(19) United States
(12) Patent Application Publication
(10) Pub. No.: US 2016/0277410 A1
(43) Pub. Date: Sep. 22, 2016

(54) METHOD AND APPARATUS FOR TRANSMISSION AND RECEPTION OF SECURE EPHEMERAL MEDIA

(71) Applicant: StoryCloud, Inc., San Diego, CA (US)

(72) Inventors: Kenneth J. KALB, Solana Beach, CA (US); Michael W. TRACY, Solana Beach, CA (US); Christina LIAO, San Diego, CA (US); Thomas H. BUSCHER, Los Angeles, CA (US)

(21) Appl. No.: 14/660,889

(22) Filed: Mar. 17, 2015

(51) Int. Cl. H04L 29/06; G06F 21/62; G06F 19/00

(52) U.S. Cl. CPC H04L 63/102; H04L 63/0876; H04L 63/108; H04L 63/107; G06F 19/327; G06F 21/6245

(57) ABSTRACT

The system provides a method and apparatus for providing a dynamic link to ephemeral content. The system and method receives a content from a first device. The method and apparatus receives a set of permissions associated with the content. The method and apparatus provides the dynamic link to the content to a second device based on the permissions associated with the content.

### BACKGROUND OF THE SYSTEM

Social media networks have become ubiquitous in the present environment. Such networks are used by millions of users on computers, mobile devices, smart-phones, tablets, and other devices that are capable of interacting with a computer network such as the Internet. Many users have been frustrated by the way that social networks are currently implemented. It is often desired to utilize a social network for personal goals and to create one or more particular networks of friends and/or colleagues for specific users. However, using current technology it is different to achieve all the goals of a user. For example, it is difficult to create separate groups of friends and other users for specific purposes without overlap into other groups. For example, if a Facebook user desires to create different groups it generally requires the user to create multiple Facebook pages and to limit access to each page to specific desired users. Because of naming conventions and limitations in Facebook, it may be difficult to even name each page in the desired manner. In addition, each page may have more or fewer features than is desired for the intended purpose. The ability to customize the system for a desired purpose is limited.

Additionally, providing different types of content and messaging services play a large role in social media services. For the purposes of user security, it is often desirable to have a mechanism to provide limitations on who can view a particular message. Furthermore, once a message or content is transmitted, there is no way to retract the message or the content. The content cannot be retracted because it may have been shared by several users and the user has absolutely no control over those shared instances.

Moreover, in this day and age, time is a precious commodity. Certain activities such as financial transactions, renovations, large scale projects, or estate planning are often difficult to organize and ensure that all of the appropriate documentation is acquired in an efficient manner. Frequently, a user may supply several documents to an agent and then be asked for several more for several days. This presents a huge time consuming hassle to the user. Therefore, it is difficult to transmit secure content, while still maintaining control of who, where, and when a user of a social media service can access content and/or media. And it is also difficult to provide a content template service that enables efficient content collection and permissions based, controlled sharing.

### SUMMARY

The system provides a method and apparatus for allowing the creation of customized private social networks through a dashboard interface. A user invokes the social network building interface and selects desired features for the network by selecting one of a plurality of possible features. When a feature is selected, the system guides the user through parameters and metrics to implement that feature as desired by the user. The system is implemented through a cloud based architecture that provides components that are used in the private social network, including services such as database, caching, load balancing, security, encryption, dynamic link control, and others. These services and components are accessed and invoked through a series of function calls through an API that allows the creation of a scalable number of private social networks. The function calls define what features will be present in a private social network. The dynamic link control allows the network to control read and write privileges, permissions and other accesses for who, what, when, for how long and on what device, a particular piece of content or service will be available.

The system also provides a method and apparatus for controlling content accessibility when provided to the social network. The method and apparatus uses the same features and architecture discussed above to implement the controlled access.

The system also provides a method and apparatus for providing templates to devices based on a particular activity, transaction, or project. Several templates directed to similar activities, transactions, and/or projects may be provided by different entities from the device. Moreover, the system has the capability of automatically populating portions of the template for which the system already has corresponding data. Based on the type of template that is being completed, the system may also present new template options that may complement the purpose of the original template. And finally, the system may be capable of generating temporal reminders to complete and update certain types of templates that may be kept for long periods of time such as templates related to estate planning.

It is understood that other aspects of methods and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 is an example of a cloud of single purpose servers in an embodiment of the system.

FIG. 2 is an example of a single purpose server in an embodiment of the system.

FIGS. 3A-3D illustrate a mobile user interface in an embodiment of the system.

FIG. 4 is a flow diagram illustrating the creation of a PSN in an embodiment of the system.

FIG. 5 is a flow diagram illustrating the operation of the system in providing access to content via a link in one embodiment.

FIG. 6 illustrates an example of the sharing of content in one embodiment of the system.

FIG. 7 illustrates the display of a mobile device in one embodiment when content is accessed using the system.

FIG. 8 illustrates an exemplary embodiment of a device that is used to set up a secure message for transmission.

FIG. 9 illustrates an exemplary embodiment of a device that is in receipt of a secure message.

FIG. 10 illustrates another exemplary embodiment of the system shown on a device.

FIG. 11 illustrates an exemplary embodiment of a device that has just received an alert that a secure message is ready for review.

FIG. 12 illustrates another exemplary embodiment of a device.

FIG. 13 illustrates an exemplary embodiment of a device that may be used by the recipient of the image transmission described with respect to FIG. 12.

FIG. 14 illustrates an exemplary embodiment of the system for providing content that flows across various time zones.

FIG. 15 conceptually illustrates an exemplary embodiment of a process for ephemeral location based content deployment.

FIG. 16 illustrates an exemplary embodiment of a device for providing a template that may be populated with ephemeral content.

FIG. 17 illustrations an exemplary embodiment of a device that provides a template obtained through crowd sourcing.

FIG. 18 illustrates an exemplary embodiment of a device with the ability to auto populate.

FIG. 19 illustrates an exemplary embodiment of a device after a user interaction has been received to auto populate the template.

FIG. 20 illustrates the exemplary embodiment of a device in the process of submitting the template and receiving a response from the submission.

FIG. 21 illustrates an exemplary embodiment of a device that may present a predicted list of other offers or opportunities to the user.

FIG. 22 conceptually illustrates an exemplary embodiment of a process for providing ephemeral, controllable content through a template.

FIG. 23 illustrates an exemplary embodiment of a device for setting reminders to revisit life planning documents.

FIG. 24 conceptually illustrates an exemplary embodiment of a process for setting reminders to visit or revisit certain types of templates.

FIG. 25 illustrates an embodiment of the system.

FIG. 26 illustrates an example computing environment of the system.

### DETAILED DESCRIPTION OF THE SYSTEM

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean serving as an example, instance, or illustration. Any embodiment described herein as “exemplary” is not necessarily to be construed as preferred or advantageous over other embodiments. Likewise, the term “aspect” of an apparatus, method or article of manufacture does not require that all embodiments of the invention include the described components, structure, features, functionality, processes, advantages, benefits, or modes of operation.

### System Embodiment

The system provides the ability for any user to easily create a private social network (PSN). The system is implemented through a cloud server based architecture having components that are used in developing, testing, and producing a scalable number of PSNs. FIG. 1 is an example of one embodiment of the architecture of the system.

FIG. 1 shows a cluster of single purposes servers including Development server 101, Test server 102, Production 1 Server 103 and Production 2 Server 104. The servers are implemented in the cloud and can be accessed through a network such as the Internet. The system is scalable such that any number of single purpose servers can be instantiated to provide the necessary services and functions to support the creation and management of PSNs. Although not shown in FIG. 1, each of the single purpose servers can communicate with third party applications as needed.

Each server cluster is a self contained entity using, for example, the Apache Hadoop system for storage and large scale processing of big data. Each cluster is capable of running approximately 1,000 machines. The server clusters may be implemented in, for example a cloud service such as Amazon Web Service (AWS). Each server cluster is virtually cordoned off in their own network separate from the other servers in the AWS. The system in one embodiment uses Java to control the database, APIs, and function calls. Redis is a caching application that is used in one embodiment. The system is easily scalable because a new server cluster can be cloned from an existing server cluster in a matter of moments. The creation of new server clusters may be driven by volume or performance. For example, it may be more useful to clone a new server cluster in a geographic location closer to a user base, including crossing international borders to provide more responsive service.

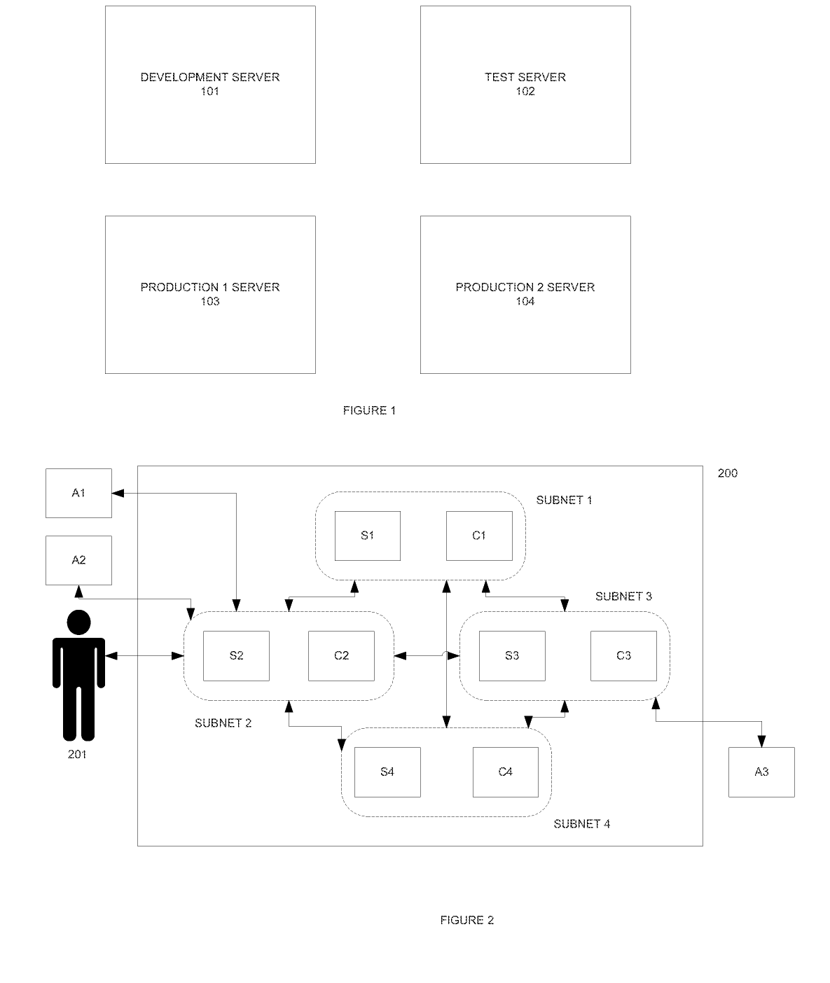

FIG. 2 illustrates the architecture of one example single purpose server. The single purpose server 200 is comprised of a plurality of subnets (Subnet 1-Subnet 4). Each subnet comprises a plurality of services S and clusters C such as services 51 and clusters C1 in Subnet 1, services S2 and clusters C2 is Subnet 2, services S3 and clusters C3 in Subnet 3, and services S4 and clusters C4 in Subnet 4.

The single purpose server 200 can communicate with users and with third party applications such as applications A1, A2, and A3. In one embodiment, application A3 may be an application controlling a PSN created by the system and is therefore considered to be “within” the PSN system. Applications A1 and A2 may be third party applications that are “outside” the PSN system but yet have access to, or may be accessed by, users within the PSN system. The third party applications could be public social networks that interact with the server 200 or it may be a service application (e.g. Amazon S3) that is associated with managing the cloud environment. The clusters may be implemented as virtual clusters using virtual machines (VMs). The VM may run Java or some other bytecode enabled system. The user of virtual clusters allows more scalability and live migration of memory and files, and dynamic deployment of additional virtual clusters as needed.

Each single purpose server 200 provides services in each such as database, caching, load balancing, security, encryption, dynamic link control, web server control, and storage and large-scale processing of data sets on clusters (e.g. Apache Hadoop) and others. These services and components are accessed and invoked through a series of function calls through an API that allows the creation of a scalable number of private social networks. The function calls define what features will be present in a private social network. The dynamic link control allows the network to control read and write privileges, permissions and other accesses for who, what, when, for how long and on what device, a particular piece of content or service will be available.

Each of the Subnets 1-4 can communicate with any of the other Subnets. Communication extends to the Services and Clusters within each Subnet. In one embodiment, one Subnet may provide security functions, including encryption, validation, permissions, and the like. Another Subnet may provide performance related functions such as memory management, caching, database control and the like. Another Subnet may provide operational functions such as communication, applet operation, Internet interface, and the like. Another Subnet may provide the functions and functionality that run the PSN.

PSN Creation

The system provides a method and apparatus for creating a private social network using an application. The result is an autonomous social network where the creator becomes the owner and/or administrator. In one embodiment, the system is implemented via a mobile app on a smart-phone, pad computer, tablet computer, or any other mobile computing device. The system may also be implemented on a desktop computer. Once created, the private social network can be accessed by any of the authorized users/members on any computing device that can access a network such as the Internet or other suitable network.

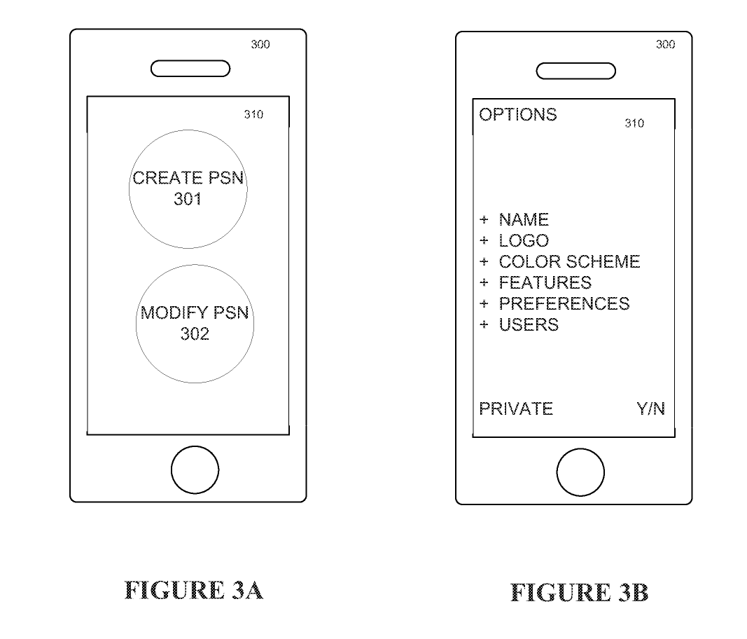

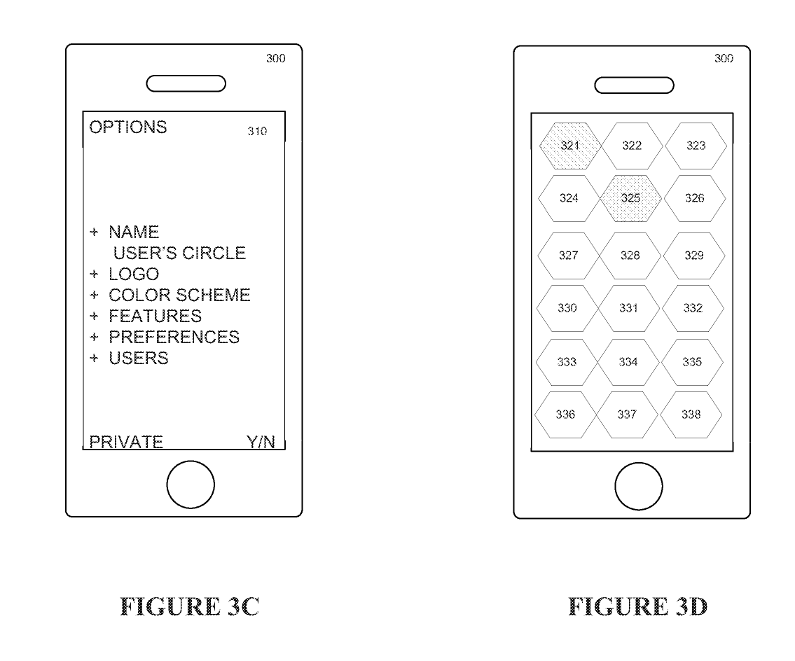

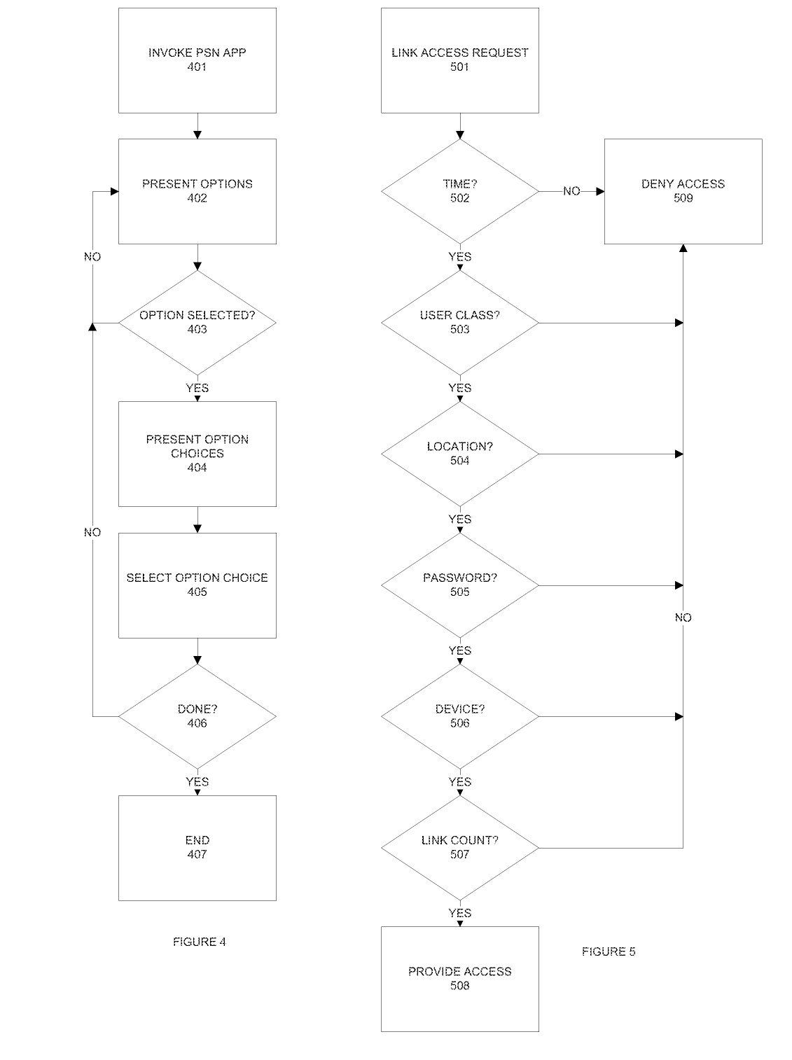

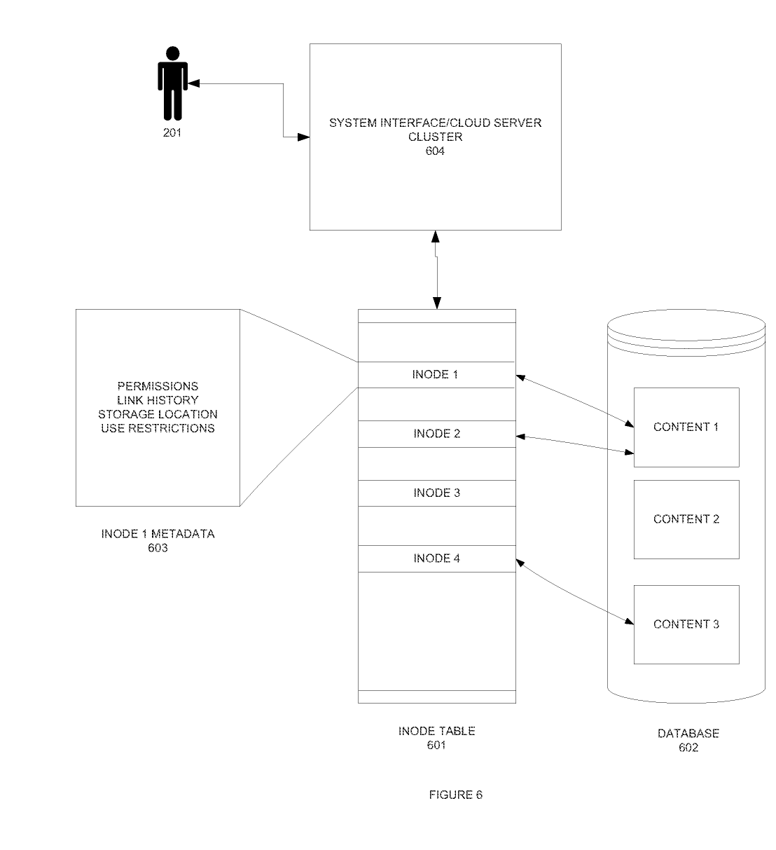

FIGS. 3A-3D illustrate an example of the user interface for the creation of a private social network on a mobile device in one embodiment of the system. Referring first to FIG. 3A, a smart-phone 300 includes a display region 310 that is typically a touch sensitive screen so that user input may be detected and converted into some action by the device. After the application is invoked, the user is presented with a choice to create a PSN 301 or to modify an existing PSN 302 The system contemplates the ability to create, manage, and modify a plurality of PSNs.

When the user has selected Create PSN 301, the display changes to that of FIG. 3B. The display 310 now presents a plurality of options that the user will select to define different aspects of the PSN. In one embodiment, the system or the user may have pre-defined default selections for some or all of the parameters, while in other cases, the owner will go through all of the options when creating a PSN. In the example shown, the system presents options for Name, Logo, Color Scheme, Features, Preferences, and Users. There is also a way to make the social network private or not as desired. In practice, all of the networks created using the system can be considered to be private social networks in the sense that they are created individually by each user. However, the PSN may allow some limited and controlled public access to non-users as a way of inviting additional users or for other purposes.

In one embodiment, each of the options includes “+” next to its identifying term to indicate that the selection of an option will present additional choices. For example, if the owner selects “Name”, the display will change to that as shown in FIG. 3C. When Name is selected, a text box is opened below the Name option and a keyboard is presented to the user (or a physical keyboard may be used). In the example shown, the owner has named the new PSN “User's Circle”. Being able to name your PSN is an advantage over prior art social networks.

When the owner selects Features, the display changes to that shown in FIG. 3D. FIG. 3D illustrates a plurality of features 321-338 that can be selected by tapping on the respective feature shape. Although 18 features are illustrated, the number of features can be changed and can be on one or more pages as desired. When a feature is selected, the color, shading, or border of the feature changes to show the owner that the feature has been selected. As shown in FIG. 3D, features 321 and 324 have been selected. Examples of features can be as follows in Table 1

TABLE 1

| | | |
|---|---|---|
| PERMISSION 321 | STORAGE 322 | CALENDAR 323 |
| MAIL 324 | STORYLINE 325 | PUBLISHING 326 |
| SHARE 327 | MESSAGING 328 | PURCHASE 329 |
| ANALYTICS 330 | SETTINGS 331 | HISTORY 332 |
| EVENT/ | PROJECT LISTS | UPLOADER 335 |
| SCHEDULER 333 | 334 | |
| POLLS/ | CLASS/ | 338 |
| VOTING 336 | ACHIEVMENT 337 | |

These are given by way of example only, and other features may be presented without departing from the scope and spirit of the system.

Permission 321 provides options related to permissions. Storage 322 provides the ability to store PSN digital assets, to organize by tag of digital assets, and to organize by contributor/user. Calendar 323 is a shared calendar that can be used by the members of the PSN to identify events related to the group. Mail 324 provides a private and secure mail feature for the PSN, with the additional feature of being verified so that mail recipients can trust that the sender is a verified user. An example of the verified mail system is described in pending patent application Ser. No. 14/455,595 filed on Aug. 8, 2014.

Storyline 325 provides a member the ability to automatically build a narrative of activity associated with the member. The Storyline can be supplemented by other members via interaction with the member or by manually adding data to the Storyline of the member. Publishing 326 provides options relating to publishing. Share 327 provides options related to sharing. Features related to publishing 326 will be discussed in greater detail in the forgoing paragraphs.

Messaging 328 provides the ability for in-PSN messaging for the private social network. This feature can build an automatically populated messaging asset that can be used as an instant messenger or SMS type messaging system. Messaging 328 can be defined as 1 to 1 or group messaging. Messaging 328 will be described in greater detail in the forgoing paragraphs. Purchase 329 provides the ability to handle financial transactions in the PSN. This activates a process that allows members to pay dues, donate to charity, handle financial transactions related to offers of sales to third parties, and the like. Analytics 330 provides statistical data associated with the PSN, and may be tied to activities of the members, purchasing information, and other analytical information that can be used to qualify the performance of the PSN.

Settings 331 provides options related to settings. History 332 provides the ability to keep a history of activity, messaging, and other data associated with the PSN. Event/Scheduler 333 allows a member to send invitations to other members and includes an RSVP function and possibly offers (e.g. raffle tickets, attendance fee handling, and the like). Project Lists 334 provides the ability to define a set of tasks, goals, or other items that can be associated with one or more members and also tied into the calendar feature to establish deadlines.

Uploader 335 is a feature that is invoked if the PSN is to allow digital assets to be transferred to shared storage of the PSN. Uploader 335 may be used when providing content to users of the system. For instance, the system may receive content to be published to the user's PSN and/or for sharing through the use of messaging 328 Polls/Voting 336 provides the ability to define and present question and response to group members and to tally the results. The sharing of content through the use of messaging 328 will be discussed in greater detail in the foregoing sections. Class/Achievement 337 provides the ability to associate the class or status of a member of the group with the accomplishment of activities defined in the PSN. Such status may be reflected by the offering of status badges, levels, icons, or other indicators of classification associated with achievements.

The Logo option allows the owner to select a graphic image that can be used as the logo for the PSN. This image may be from the owner's own image gallery, may be downloaded from a network, or may be a choice of logo's provided by the app and system.

The Color Scheme option presents the owner with a plurality of themes and color schemes that can be used with the PSN. In some cases, the owner can select a theme and then use a color picker to adjust colors of different aspects of the theme of the PSN.

The Preferences option presents various options for the owner to select for the operation of the PSN. For example, the owner may select preferences related to data presentation, sorting of posts, publishing options (including automatic publishing within and between other public and private social networks selected by the user, tying the PSN to other accounts, and other preferences).

The Users option is used by the owner to invite and/or validate members of the PSN. In one embodiment, the system can use a list of existing friends and connections of the owner in other system PSNs and/or other public or other social networks, address books, and the like. For instance, an advertising user may generate a targeted list using information received at analytics 330. All of the described lists may be used for providing ephemeral and secure content to a specified group of users. However, as will be described below, a user may set a number of different parameters for limiting who receives a particular content and/or message.

The system allows an owner to create a PSN with only those features desired by the owner to be implemented in the PSN. For example, if the owner does not need the ability to purchase goods or services in the PSN, the user does not select the Purchase feature when creating the PSN. This gives great flexibility and adaptability to the owner in generating multiple PSNs. A PSN can be custom designed to fit its purpose in a way that is not possible in prior art social networks.

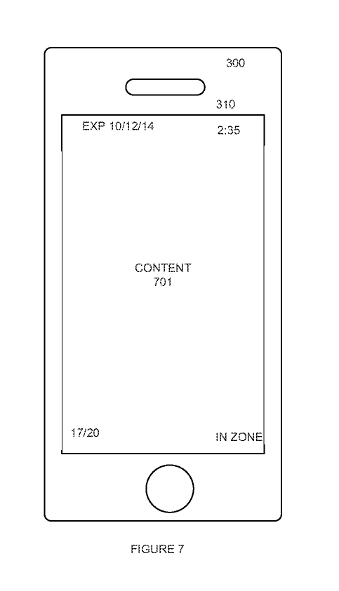

FIG. 4 is a flow diagram illustrating the generation of a PSN in one embodiment of the system. At step 401 an owner such as 201 in FIG. 2 invokes the Create PSN app on a computing device (e.g. a smart-phone). The invocation of the app on the computing device includes a connection to one or more of the single purpose servers in the cloud computing environment, such as server 200 of FIG. 2. In one embodiment, the selection of the options and features of the PSN takes place locally on the computing device and after all selections have been made, the build of the PSN takes place on the server 200.

At step 402 the system presents options to the user 201, such as those shown in FIG. 3B. At decision block 403 the system determines if an option has been selected. If not, the system returns to step 402. If so, the system presents the possible choices for the option at step 404. For example, if the owner has selected the Name option at step 403, the system shows a text field for entry of the name of the PSN as shown in FIG. 3C. If the owner has selected the Feature option at step 403, the system shows the Feature picker as shown in FIG. 3D.

At step 405, the owner makes a choice of the presented option (e.g. choosing a name or selecting one or more features, preferences, color schemes, selection of users, and the like). At decision block 406 it is determined if the owner is done creating the PSN. If so, the system ends at step 407. If not, the system returns to step 402.

In one embodiment, the features of the PSN are built locally on the owner's computing device and are then transmitted to the cloud where the PSN is formed based on the selections. In another embodiment, the owner's computing device is in connection with the cloud of servers and the PSN is built as the owner interacts with the PSN building application.

When a new PSN is built, the resources for running and managing the PSN are established in the cloud of single purpose servers and the PSN is available for use by the members of the PSN.

The ability to create and use PSNs provides use scenarios that are difficult or impossible to achieve using typical social media networks or existing tools. For example, a sports team can create a PSN just for their team. Team members can use the shared calendar and event scheduler to provide both passive and active notification of when and where the next game will be. The RSVP function helps confirm maximum participation. Additionally advertisers can generate groups using their own predetermined groups or groups determined by analytics 330 to provide directed promotional material.

A family can create a PSN just for the close family (e.g. parents and children). The family can coordinate their schedules, vacation plans, plays and other family events using the shared calendar and chat feature. Many children do not want their parents to be their “friends” on prior art social networks. A family PSN provides all the usefulness and tools of the social network without the perceived embarrassment of being online friends with a parent.

Controlled Data Access

In addition to the flexibility of creating a plurality of PSNs, the system includes additional protection for content that allows the owner of the content to determine and fully control who, what, where, and when/how long a content file is being shared. Whenever a member of a PSN links to content, they will have the ability to set granular controls, permissions, and limitations on the use and accessibility of the content or digital asset. In addition, the member can determine if the content will be sharable outside of a particular PSN, whether to other PSNs (e.g. application A3 of FIG. 1) or outside the PSN system (e.g. applications A1 or A2 of FIG. 1). Regardless of whether the content is to be shared within or without of the PSN system, the member can set limits to particular users, classes of users, or other access levels related to the content.

The content can be any digital asset including pictures, videos, documents, messages, and the like, and content can be accessible on devices, through the PSN, via the cloud, and the like.

The member of a PSN can set default options that may apply to all content that is created, with the member then adjusting settings as desired to provide more or less access to the content. Table 2 gives examples of the types of permissions that can be applied to content using the system.

TABLE 2

| | | | | |
|---|---|---|---|---|
| Start Time | End Time | Location | PSN Member | PSN System |
| | | | | Member |
| Link Count | Modify File | Share Link | Analytics | Password |
| | | | | Protect |
| Repeat | Event | Outsider | Device | Financial |
| Views | Tie-in | | Limits | |

The Start Time defines when the content will be available. This allows the user to set up permissions that will make content available in the future so that content can be scheduled in advance, without releasing the content. A link that is associated with the content will not operate if the Start Time has not yet occurred. The End Time defines when the access to the content will be terminated. The default for the Start Time may be that it is available upon uploading to the system and the End Time is open ended. Alternatively, a duration may be set rather than a start/end time. The duration would indicate the duration that a content is available from the time that the link is provided to other users of the PSN(s). The content owner is free to set any defaults for uploaded content. In one embodiment, the defaults may be tied to content type, with specific default profiles for text, audio files, video files, images, etc.

The Location setting may be used to set a geographical limitation on where the link to the content will be effective. For example, the content owner may only make the content link active at a specific location, such as a store, home, park, business, or the like. The system allows the owner to define a distance from a location in which the content link will be usable. The content owner may also limit access to the link to a PSN Member, a PSN system user, or it may be available to outsiders. The owner may require an outsider to register with the PSN system in order to be able to access the content link. In one embodiment, the content owner can access a map and use it to define a location at which content may be either viewable or prohibited, as desired. The user will also be able to use addresses, zip codes, or other location metadata to define protected geographical regions. Once a location has been determined, the content owner can use a slider or some other means to define the radius about which the content is available. In other embodiments, the user can define the region by drawing a boundary on the map, so that non-circular regions may be defined.

The Link Count can be used to set a number of times the link can be used to access the linked content. When the Link Count is exceeded, the link is rendered inactive. Repeat Views may be used to allow a user of the content link to use it more than once or to be limited to a single access. The Device Limits setting may be used to restrict access to the content link to a type of device either generically (e.g. a smart-phone), by producer (e.g. an Apple device), or even to restrict access to a single device, by tying access to a particular UDID or some other indicia that can be used to reliably identify a particular device. The link count can be bounded by number of impressions, unique views, particular user, time period, duration, and the like.

The content link may be password protected in that a person accessing the link will need to provide a password or respond to some other challenge before access to the link is given. The content owner can set the link to track and provide Analytics associated with use of the link, including identity of who accessed the link, how many times, for how long, and the like. The Share Link setting can be used to allow or restrict sharing of the link with others. If the link is sharable, all of the restrictions associated with the link stay with the link, so that protection is maintained.

The share link may be transmitted or communicated in any of a number of ways, including email, phone number, SMS, text, or any other suitable manner.

In some cases, the content owner may permit the user of the link to modify the content. This ability to modify the content may add another level of restrictions on who can modify, or it can apply to all users. The ability to modify can be parsed to one or more of a plurality of modification options, including overwriting, editing, adding audio, and the like.

The content link can have a connection to other events, such as a concert, sporting event, or other event, where the beginning and/or end of the event will define the accessibility of the content link. In one embodiment, the content link can have a financial component where a viewer may be required to pay for either viewing or to expand other permissions associated with the content link.

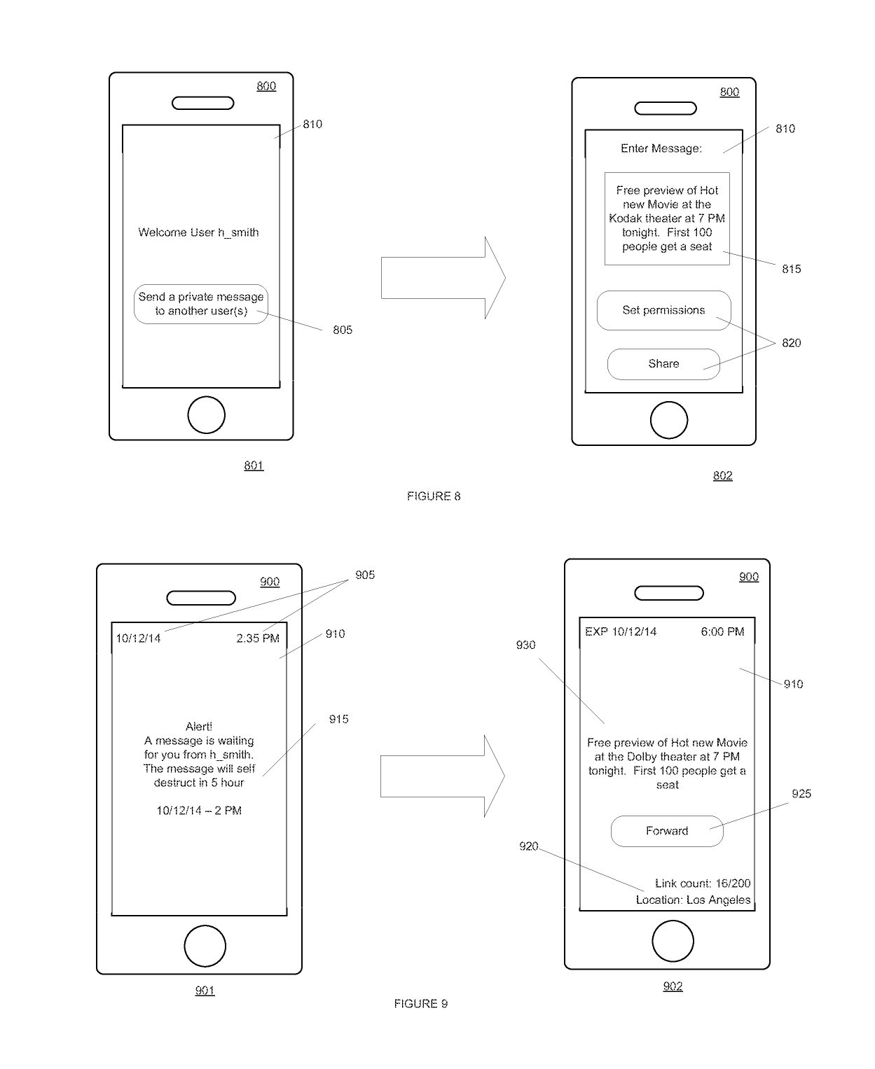

FIG. 5 is a flow diagram illustrating the operation of the system in providing access to content via a link in one embodiment. At step 501 someone makes a request to access the content link. At decision block 502 the system determines if the attempt to access the link is being made during the active time frame of the link. As noted above, this can be a fixed start and end period, or it may be tied to an event or some other time dependent trigger. If the access is not timely, the system denies access at step 509.

At decision block 503 the system determines if the user attempting access is in the approved user class as determined by the creator of the link. An approved class may include any group or individual users capable of accessing the content by the link. If so, the system proceeds, if not, access is denied. At decision block 504 it is determined if there is a location restriction and if so, if the user is within the designated geographic location for accessing the link. This may be determined by geo-location information provided by the access device of the user (e.g. smart-phone). At decision block 505, if there is a password requirement, the system requests it and checks for the proper password. If the password is not correct, the system may provide a certain number of retries. If the user fails to provide the password, access is denied.

At decision block 506 it is determined if there is a device requirement for access, and if so, whether the user is accessing the link on the correct device. This can be determined by IP address, UDID, MAC address, or some other reliable indicator of the device being used. At decision block 507 it is determined if the access request is within the number of allowed link requests. This number may be on a per-user limit or a total access limit for the link, as defined by the creator of the link. If the decision blocks are not satisfied, access is denied. If all are satisfied, the system provides access to the link at step 508.

When the viewer has access to the content, there are still restrictions associated with the content. The content is shared via the link, and is not resident on the viewer's device. Screenshot capability on the device is disabled to prevent the content from being captured by the device. Saving and forwarding the content is prohibited, although forwarding the link may be permitted. In some cases, the content may be modifiable by the user, depending on the permissions set by the content owner. In addition, the files will typically be encrypted to further provide protection.

The system allows the owner of content to have many levels of control and management over the content. By requiring all content to be accessed by link, the system allows a content owner to permanently remove content by eliminating the link to the content. This allows someone who posts a regrettable piece of content (unflattering picture, controversial post, and the like) to remove that content so that it is no longer accessible. This has advantages for content owners who want to sanitize their youthful exuberance and to present a more responsible face to employers, friends, relationships, and the like.

In one embodiment, the system implements the content links via and index node, referred to as an inode. The inode is a data structure that is used to represent an object (which can be any type of digital content). The inode includes attributes which can be used to characterize access to the referenced object, including access permissions, manipulation controls, and other content management metadata.

It is possible to have a plurality of inodes pointing to the same underlying data file (content). This allows the content owner to further customize access and manipulation possibilities of the underlying content. The content may be stored in “collection groups”. A particular content or resource may be found in more than one collection group.

FIG. 6 illustrates an example of the sharing of content in one embodiment of the system. A user 201 attempts to access a content link by communicating in the system through a system interface (e.g. PSN) at system interface/cloud server cluster 604. The server cluster 604 includes an inode table 601 that stores a plurality of links/inodes such as inodes 1-4. A database 602 is coupled to the link table and stores a plurality of content, such as Content 1, Content 2, and Content 3.

Inode 1 is illustrated in more detail in inode 1 metadata block 603. An inode includes permissions, link history, storage location of the content, use restrictions, and other metadata and control information that can be used by the content creator as described above.

As shown in FIG. 6, a particular content may be associated with one or more inodes. For example, Content 1 is associated with inode 1 and inode 2. Each inode can have its own associated permissions, access rules, modification rules, and the like. The content owner can create as many links or inodes to the same piece of content as desired, with each one being customized accordingly.

FIG. 7 illustrates the display of a mobile device in one embodiment when content is accessed using the system. The mobile device 300 displays the content 701 on the display 301. The content can be image, video, audio, document and the like. On the top left of the display 301 the system displays the expiration date (if any) of the content. The top right illustrates a countdown timer to show how much longer the content 701 may be viewed. This timer may refer to a current viewing session, an overall time limit associated with the content, an overall time limit associated with this particular viewer, and the like.

In the lower left of display 301, the system may display the number of views used and the total number of views available (e.g. this is the 17^{th} view out of 20 available). This may refer to the content for any user or it may refer to the content for this particular user. The lower right corner can be used to indicate if the user is in or out of the geo-location required (if any) for viewing the content. This is based on the device location and may or may not be a restriction, depending on the content owner.

Secure Content and Access Management

As discussed above, the system also provides the ability for users to securely transmit messages and/or content to other users of the system by only providing links to the recipients viewing the content. As will be discussed below, the content may be shared in a number of different ways including simple transmission or by populating a template with content. The simple transmission aspect of the system will now be discussed in greater detail in the following section, while the template aspect of the system will be discussed in the section following section following. Additionally, the following FIGS. 8-24 will be described in connection with FIGS. 5 and 6. The secure messages/content, whether organized within a template or not, may be transmitted by providing a dynamic link to the receiving users, as described above with respect to FIG. 6. For example, a message or contents of a template may be stored as a content in database 602. The receiver may access the message/content by way of a dynamic link by checking inode table 601. This enables the sender to destroy access to the message or template content at anytime. Furthermore, the sender can control access to the content by setting permissions which are maintained in metadata block 603.

The user may initiate the messaging process by selecting messaging 328 as shown in FIG. 3D. The following figures illustrate the system after a device has received a selection of messaging 328 to set permissions and provide a link to a message, or uploader 330, which enables the device to transmit content for storage on the system.

Secure Ephemeral Message Transmission

FIG. 8 illustrates an exemplary embodiment of a device 800 that is used to set up a secure message for transmission. FIG. 8 illustrates two stages 801 and 802 of a user's interaction with the device 800. The device 800 includes a display area 810. The display area includes a selectable user interface (UI) object 805, which upon selection causes some event or action to occur in the display 810 of the device 800.

As shown, in the first stage 801, the display area 810 displays a message to the user of the system having set up a particular username. The username may be tied to a particular PSN or multiple PSNs. The selectable UI object 805 enables a user to set up a message for secure transmission upon receiving a user interaction with the selectable UI object 805. Such an interaction may be a gestural interaction such as tapping the area in or around the object.

The second stage 802 illustrates the device 800 after receiving the user's interaction with the selectable UI object 805. As shown, the display area 810 of the second stage 802 includes a message 815, and selectable UI objects 820. The selectable UI objects enable a user to set permissions such as who can access the message, in what location(s) the message may be accessed, and how long the message will remain accessible. Reference to FIG. 6, the permissions are used to determine how long a particular inode in inode table 601 will link to a particular content in database 602. When the content is no longer accessible, the link from the inode to the content will break. Additionally, selectable UI objects 820 include a share button. Once the sender has set the appropriate permissions for viewing the content, which are maintained by the inode table, the user may interact with the share UI object to share the message based on the set permissions.

FIG. 9 illustrates an exemplary embodiment of a device 900 that is in receipt of a secure message. For instance, the device 900 may be associated with at least one of the users selected to receive the message shared in the second stage 802 of FIG. 8. The device 900 includes a display area 910, current date and time 905, and message alert 915. The device 900 is similar to the device 300 illustrated in FIG. 7. However, the device 900 differs in the placement of the expiration time is located at the top of the device display 310. In some aspects of the device, the current date and time 905 may be replaced by the message expiration time as illustrated in FIG. 7. FIG. 9 illustrates two stages 901 and 902 of a users interaction with the device 900.

In the first stage 901, the display area 910 is displaying an alert 915 that a secure message is waiting for the user of device 900 to view. The alert 915 includes information about who sent the message, the time the message was sent and when the message will become unavailable, or more specifically, when the link to the message will break. However, as discussed above, the time of expiration of the message may be displayed at the top of display area 910 or any other suitable location. The message recipient may gain access to the message by performing a gestural action with the device 900. For example, the recipient may perform a swipe interaction with the display area 910 to display the received message. However, any other suitable gesture such as a tapping interaction could be used to cause the device 900 to display the received message. As discussed above, when the recipient views the message, the system does not actually transmit the actual message to the recipient. The recipient receives a dynamic link to the message in content storage, such as content storage 602.

In the second stage 902, the display area 910 includes a message 930, permission information 920 and selectable UI object 925. Selectable UI object 925, and permission information 920, which may be optionally displayed in display area 910.

As shown in the second stage 902, the message 930 is a message that may be directed at a group of predetermined frequent movie goers. Such a group may be determined from the system's analytics capability 330 as discussed above. As shown by the permission information 920, the message may be restricted to devices located in or near Los Angeles. Additionally, the message may only be available until a specified number of views have been reached. For instance, the message 930 may have been transmitted to 250 users. However, only the first 200 users who attempt to access the message will be permitted to view the message. Whether the message is accessible by the device 900 may be determined by using a process such as the one described in FIG. 5.

Optionally, the system may provide the capability to forward messages. Such a capability may be accessed by a gestural interaction with, for example, selectable UI object 925. However, in some aspects of the system, the device 900 may only be permitted to forward the message 930 based on specific criteria. For instance, the device 900 may only be permitted to forward the message to other users with devices located within a specific radius of the Los Angeles area. Additionally, the same amount of views may be in effect, so if the forwarded message is not accessed before 200 views is reached, the message may become unavailable to the device in receipt of the forward. It should also be noted that by forwarding the message, all that is being forwarded is a dynamic link to the same message that is viewed on the device 900. Thus, the link is breakable at anytime for denial of access if the system determines that the number of forwarded messages has reached above a particular threshold, for example.

Although the examples described with respect to FIGS. 8 and 9, involve an advertisement message, the system is not limited to such messages. For instance, a personal message could be delivered using the same available permissions to only one or two other devices accessible to the system, or a personal group of users set up, for example, in the device 300 described in FIG. 3. In such instances, a private message may be sent to members of a same family that were previously set up as a group under the PSN.

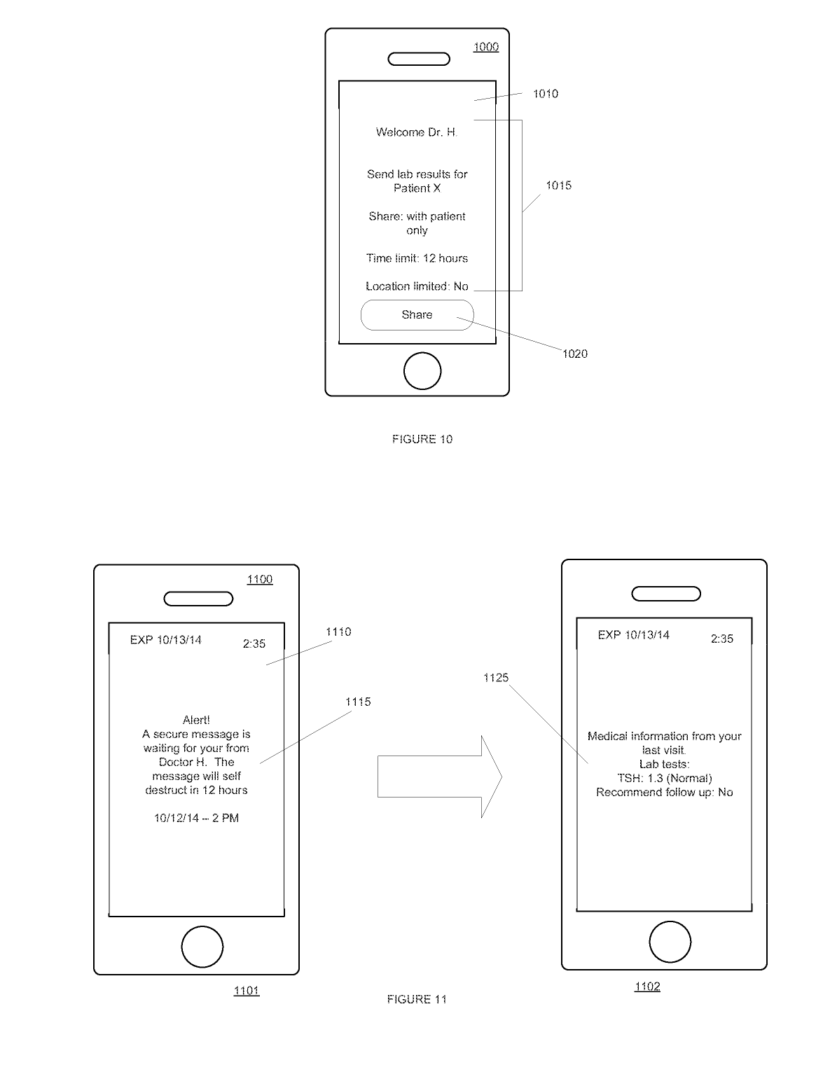

FIG. 10 illustrates another exemplary embodiment of the system shown on device 1000. Since the system provides the ability to transmit secure messages, several different uses may be realized. For instance, healthcare professionals such as doctors, dentists, nurse practitioners, and physical therapists may be able to share medical information with patients or among a team of healthcare professionals. For instance, the user of device 1000 may create a group of healthcare professionals that are involved in a patient's healthcare plan and transmit messages to the created group. In another instance, the device 1000 may simply transmit a message to only a patient based on input received from a user. Such a message may include test results, post surgical instructions, medication information, recommended exercises, or any other message involving information that may be typically provided by a healthcare professional to a patient. This is advantageous, because the patient and the healthcare professional have the benefit of knowing that the message is secure and the link to the message may be destroyed at anytime if a security concern arises. This also provides the added benefit of easily and securely communicating a plan between a team of healthcare professionals that may be at different locations. Additionally, if a mistake is made in a message, the healthcare professional has the ability to pull the message so that it is no longer available to the patient's healthcare team.

As shown, the device 1000 includes a display area 1010, message instructions 1015, and a selectable UI object 1020. The message instructions may include what message to send to which patient, how long the message may be available and whether the message is restricted by location. Referring again to FIG. 6, such information may be maintained as metadata in an inode of inode table 601. In this example, Dr. H intends to send lab results to Patient X only. Therefore, the corresponding inode may then link to a particular content that includes the lab results for patient X. The metadata stored in the inode will ensure that only a device operated by Patient X may view the content for the specified period of time as shown in instructions 1015. Once the instructions are set, the device 1000 may receive a user interaction with selectable UI object 1020 to transmit the lab results to patient X according to the permissions set in instructions 1015. Such a user interaction may include a gestural interaction such a finger tapping motion in or around the button. By transmitting the message, Dr. H, in this example, is simply requesting a dynamic link be provided from the system to patient X in order to view the lab results that are stored in the content. Thus the link is breakable after a period of time, which provides the advantage of extra security.

FIG. 11 illustrates an exemplary embodiment of a device 1100 that has just received an alert that a secure message is ready for review. Such a message may be the lab results sent from device 1000. Device 1100 includes a display area 1110 and a message alert 1115. FIG. 11 illustrations two stages of a user's interaction with the device 1100.

In the first stage 1101, the display area 1110 displays an alert similar to the alert displayed in display area 910 described with respect to FIG. 9. For instance, the alert includes who sent the message and for how long the message will be accessible. Similar to FIG. 9, the display area 1110 includes the current date and time in the top of the display area 1110. However, this could be replaced with a time of expiration associated with the message. The determination of whether a device can access a message or receives an alert that a message is available may be determined based on the process described with respect to FIG. 5.

In the second stage 1102, a message 1125 is displayed. Such a message may be displayed after the gestural interaction was received in the first stage 1101. In this example, the message 1125 includes the results of a lab test that was performed on Patient X. Although only one lab test is illustrated in this example, several more lab tests may be displayed such that it would be necessary to scroll through the display area 1110, or the results may appear on multiple pages. Additionally, the message may provide more information such as referrals to specialists, whether the doctor recommends a follow up visit, or any other message that is typically associated with information that a doctor may provide to a patient. It should also be noted that the capability to transmit ephemeral links to patient medical information may be compliant with HIPAA regulations as necessary.

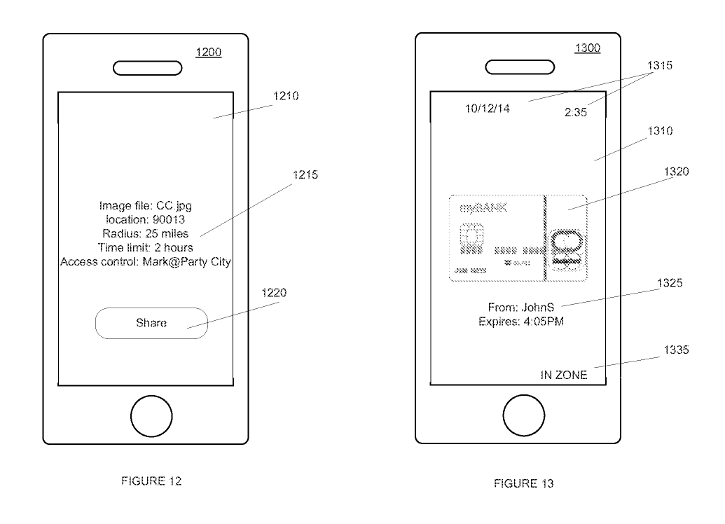

FIG. 12 illustrates another exemplary embodiment of a device. FIG. 12 illustrates a device 1200 including a display area 1210. The display area 1210 includes content and access information 1215 and selectable UI object 1220. As shown in content and access information 1215 an image file is selected.

As a benefit of providing secure, location based, ephemeral content links, users may provide potentially comprising information with the assurance that the content link may be broken at anytime and it is possible to appropriately limit who may view the content. Thus, nefarious activity may be contained and, ideally, eliminated. For example, the content information 1215 indicates that the user of the device 1200 would like to share an image of a credit card. However, the user of the device 1200 would like to limit the accessibility of the image based on locality, duration, and user. For instance, according to the access information 1215, only user Mark@PartyCity may view the content within 2 hours of when the message is sent. Additionally, Mark@PartyCity can only view the image when he is within a 25 mile radius of zip code 90013.

A gestural interaction with selectable UI object 1220 will share the credit card image by a dynamic link according to the permission information specified. The permission information may be maintained in as part of the metadata of an inode of inode table 601. The inode will also provide a link to the image maintained in the database 602. Once the time limit has expired, or upon the sender's request, the link between the inode and the content will break making the content inaccessible to any user beside the sender.

FIG. 13 illustrates an exemplary embodiment of a device 1300 that may be used by the recipient of the image transmission described with respect to FIG. 12. For instance, Mark@PartyCity may be the username of the owner of the device 1300. The determination of whether the device 1300 may access the content may be determined by using a process such as the process described in FIG. 5.

The device 1300 includes display area 1310. The display area 1310 includes date and time information 1315, image 1320, information 1325, and zone information 1335. As shown, the display area 1310 illustrates an image of a user's credit card. Transmitting such an image would typically be inadvisable under normal conditions. However, by utilizing the permissions capabilities of the system, the user gains the security in knowing that he/she can strongly limit who can view the image 1320. Such a capability may be used for any image that may compromise a user's financial security. For instance, the system could transmit links to images such as loan documents, driver's licenses, social security cards, and any other image of sensitive information.

Referring back to FIG. 13, the information 1325 provides the user of the receiving device of the link to the image an indication of when the link will break. The information 1325 may also optionally be provided to the device of the user who sent the image. The zone information 1335 indicates that the device 1300 is within the geographic zone specified in FIG. 12 and as stored in the corresponding inode metadata. If the device 1300 were to leave the specified geographic zone, the link to the credit card image would no longer be accessible because step 504 of the process described in FIG. 5 would fail causing the system to make the link inaccessible to the user attempting to access it.

Although this example does not show an alert screen such as the alerts shown in the first stages of FIGS. 9 and 11, such an alert may also be displayed in the display area 1310 before accessing the image 1320. Additionally, in this example, the date and time information 1315 illustrates a current date and time. However, in some aspects of the device, the date and time information 1315 may be replaced with a link expiration date and time as shown in the top portion of the display 310 of the device 300 from FIG. 7.

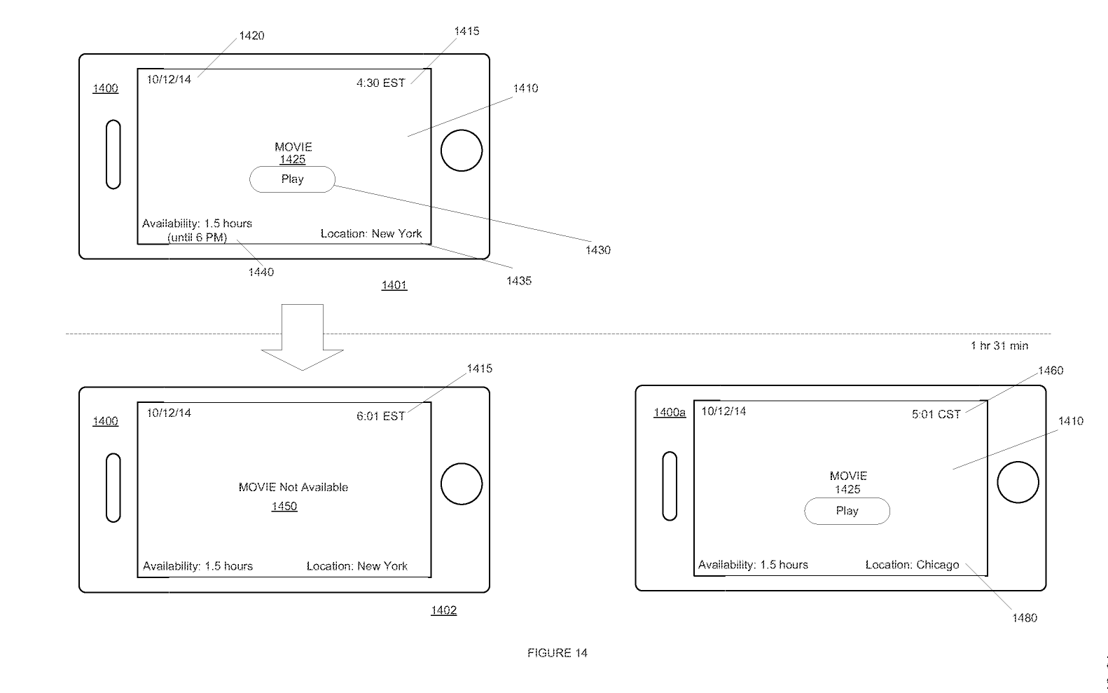

FIG. 14 illustrates an exemplary embodiment of the system for providing content that flows across various time zones. Specifically, FIG. 14 illustrates devices 1400 and 1400a, which are located in different states having different time zones. As will be described below, FIG. 14 illustrates how the system can be configured by using temporal permissions to enable access to content to different users at different times across different time zones. FIG. 14 illustrates two stages of a user's interaction with the device 1400 and the device 1400a. As will be discussed in the foregoing the device 1400 and the device 1400a are located in different time zones.

The device 1400 includes display area 1410. Display area 1410 includes current date 1420, current time and time zone 1415, content 1425, selectable UI object 1430, location information 1435, and temporal availability 1440. FIG. 14 illustrates two stages 1401 and 1402 of a user's interaction with the device 1400.

As shown in the first stage 1401, the content 1425 such as a movie is available for viewing on the device 1400 by accessing a link to the movie for 1.5 hours. In this example, the device 1400 may be connected to the system and upon selecting the selectable UI object 730, a movie may play on the device 1400. However, the movie will only be available until 6 PM as shown by the temporal availability 1440. Thus, at 6 PM EST, the link to the movie will break.

In this example, time permission information may be stored in the metadata of an inode of inode table 601. However, in this example, location information may be left blank, essentially allowing the access start and end time of the movie to travel across time zones. But, as will be shown in the following Figure, location information is important for determining the availability of the content.

The dashed line below the first stage 1401 illustrates a time lapse of 1 hour and 31 minutes. As shown in the second stage 1402, the device 1400 displays the message 1450 that the movie is no longer available because the temporal accessibility has lapsed.

Referring to the device 1400a, the display area 1410 includes time information 1460 and location information 1480. As illustrated by both the location information 1460 and the time information 1480, the device 1400a is located in a different time zone. Therefore, the time lapse has not affected the availability of the movie for device the 1400a. Thus, the movie 1425 can be available at different times that correspond to the same time across multiple time zones. The number of time zones that the content may be available in may be controlled by setting permissions as described above, which are maintained in metadata associated with an inode such as the inodes described with respect to FIG. 6. Additionally, the devices that are able to access the content 1425 may be determined by using the process described in FIG. 5.

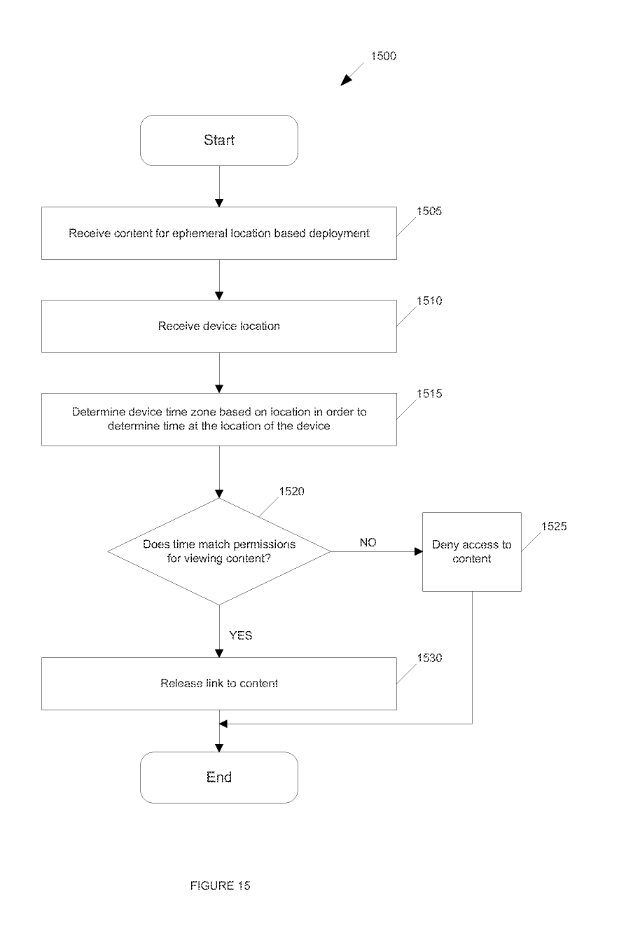

FIG. 15 conceptually illustrates an exemplary embodiment of a process 1500 for ephemeral location based content deployment such as the movie deployment described in FIG. 14. The process 1500 may run on the system described above. The process 1500 may begin after receiving permissions for accessing a particular content.

As shown, the process 1500 receives (at 1505) content for ephemeral location based deployment. In some aspects of the system, such as the example described in FIG. 7, geographic information may be optionally set. Additionally, the process 1500 may receive the permission information concurrently with receiving the content (at 1505). However, even in the case where a device location is not set, the process 1500 still receives (at 1510) device location information. Such information may be provided by the device's Global Positioning System (GPS). The process then determines (at 1515) the device time zone based on the location in order to determine the time at the location of the device.

At 1520, the process 1500 determines whether the time matches the permissions for viewing the content. For instance, the process may query the metadata stored in an inode linked to the content to determine if the permissions match the current conditions (e.g., time and location). When the time permissions for viewing the content match, the process 1500 releases (at 1530) a link to the content for the permitted period of time. The process then ends. When the process determines that the permissions for viewing the content do not match, the process 1500 denies (at 1525) access by not providing a dynamic link to the content. The process then ends.

As discussed above, the user may access templates to populate with content. Similar to the messaging discussed above, The user may initiate the template population process by selecting messaging 328 as shown in FIG. 3D. The following figures illustrate the system after a device has received a selection of messaging 328 to set permissions and provide a link to content within a template, or uploader 330, which enables the device to transmit content for storage on the system.

Secure Ephemeral Content Transmission Using Templates

In some aspects of the system it is possible to send direct communication to another user of the service in order populate a template provided by the sender. For instance, a landlord may have a standard template that he provides to potential and future tenants to populate and transmit back. The content provided to the template is provided by a dynamic link to the system. Therefore, when a user, such as a tenant no longer wishes to make the content provided to the template available to the landlord, he simply breaks the dynamic link and the content is no longer accessible.

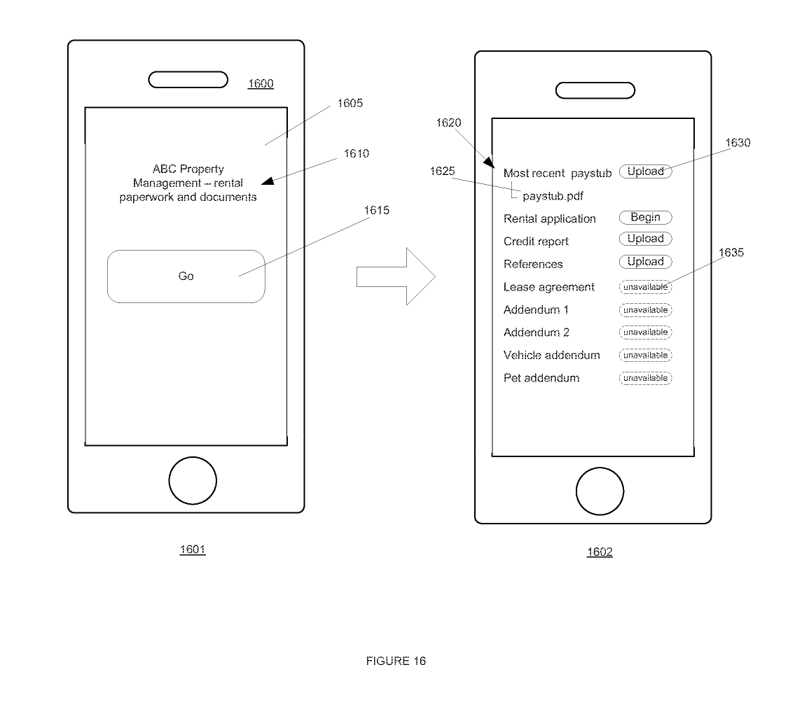

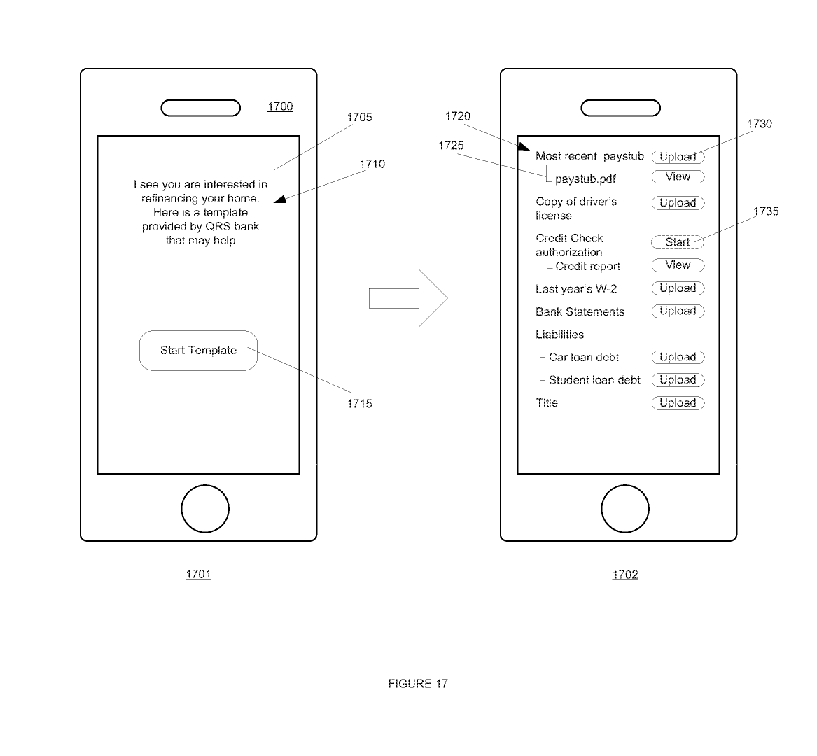

FIG. 16 illustrates an exemplary embodiment of a device 1600 for providing a template that may be populated with ephemeral content. Device 1600 includes a display area 1605, text 1610, selectable UI object 1615, template 1620, content 1625, selectable UI object 1630 and disabled UI object 1635. FIG. 16 illustrate two stages 1601 and 1602 of a user's interaction with the device 1600.

As shown in the first stage 1601, the display area 1605 is presented a message as the text 1610. The text indicates that a particular user or entity has directly provided a template to a user to populate. In this exemplary figure, a landlord has provided a template to a potential tenant. Upon receiving a user interaction with the selectable UI object 1615, the user may begin to populate the template by interacting with the device 1600.

In the second stage 1602, several requests to upload content as well as several pre-generated forms are available within the template 1620. For instance, the device 1600 may receive an upload from the user of a recent paystub as requested by the template creator. The template creator also has the ability to make certain parts of the template available to the user while disabling other features. For instance, in this exemplary figure, the user may be in the process of getting approval to engage in a rental agreement. Additional features may be enabled upon receiving approval from the template creator so that the device 1600 may begin to receive user input at the different forms associated with the lease agreement.

As illustrated in the second stage 1602 several of the selectable UI objects 1630 are enabled, while several of the selectable UI objects 1635 are disabled. As shown, the unavailable features are associated with the selectable UI objects 1635 that have a visually distinct appearance to the selectable UI objects 1630 that are associated with available features. Such distinctions may involve the color or shading of shading of the UI object. Other distinctions may involve displaying text that clearly indicates which features are available and which are currently disabled. For instance, as illustrated in FIG. 16, the disabled features correspond to the selectable UI objects 1635 that indicates the are “unavailable.” In addition, the “unavailable” selectable UI objects 1635 are enclosed in dash lines while the available selectable UI objects 1630 are enclosed in solid lines and show different text that may be indicative of the functionality associated with the corresponding feature. For instance, the device 1600 may ask the user to upload several different items as well as begin filling out different forms that are attached to the template. Once the appropriate information has been presented to the template, the content may be transmitted back to the template originator based on a received user interaction. However, as discussed above, the content is provided by a dynamic link from an inode of the inode table 601 to content stored in the database 602. Thus if the user decides to remove any content at anytime, the system may receive a user interaction to break the inode link.

FIG. 17 illustrations an exemplary embodiment of a device 1700 that provides a template obtained through crowd sourcing. For instance, a business user, such a as a contractor or loan officer may upload different templates to the system and based on permissions, the templates may be available to the devices communicating with the system to assist device users in the process of efficiently gathering the appropriate content for completing a particular activity, such as a transactional event. The template permissions may be set using a process similar to the process described in FIG. 5.

The device 1700 includes a display area 1705, text 1710, selectable UI object 1715, template 1720, content 1725, and selectable UI objects 1730 and 1735. FIG. 17 illustrates two stages 1701 and 1702 of a user's interaction with the device 1700.

As shown, in the first stage 1701 illustrates a message as the text 1710 inviting a user to use a template previously created by a bank that lays out all the content required for refinancing a home. In some aspects of the device, the display 1705 may present several different template options from different template available from the system by different creators and that are associated with the same type of transaction. In such aspects, the device 1700 may receive a selection of the desired template. Additionally, in some aspects of the device, the system may predict that the user is interested in preparing documents for this particular transaction based on collected analytical data, which may include search and viewing history as well as certain demographic information such as whether the user is currently a homeowner. Such analytical data may be recovered from the analytics 330 of a PSN.

Upon receiving a selection of the selectable UI object 1715, the display area 1705 may display the template 1720 in the second stage 1702. Within the template 1720 may be the content 1725. As discussed above, the content is provided by dynamic link from the inode table 601 and may be removed at anytime by the user that provided the content by simply breaking the dynamic link.

In this exemplary figure, the device 1700 may have already received some user interaction to upload the content to the template 1720 such as the “paystub.pdf” file. The device 1700 may also have received user interaction to fill out a credit check authorization form. As a result of filling out the credit authorization form, the user's credit report is now included in the template 1720. Additionally, since the credit authorization document has already been filled out the associated selectable UI object 1735 may be disabled. However, the device 1700 now has enabled the ability to view the credit report.

In some aspects of the device, it may be desirable to replace already loaded content. For instance, the user may wish to provide a new paystub or more current paystub. In such instances, the upload selectable UI object 1730 is enabled. Upon receiving a user interaction with the selectable UI object 1730, the device may replace the previously uploaded paystub file or add an additional content file to the template entry. Similarly, replacing content would cause the dynamic link to the replaced content to be broken. Additionally, some aspects of the device may provide the capability to view all content that has been provided to the template 1720 so that it may be reviewed for accuracy.

In some aspects of the system, it may be simple to pre populate some of the required template information using information that is already associated with the user's PSN. Such information may be automatically input upon opening the template, or may populate after the device has received some interaction from the user instructing the device to gather information to automatically populate the template with available content. Additionally, in some aspects of the system, the template may auto populate and then the device will signal the user request(s) to provide the missing content.

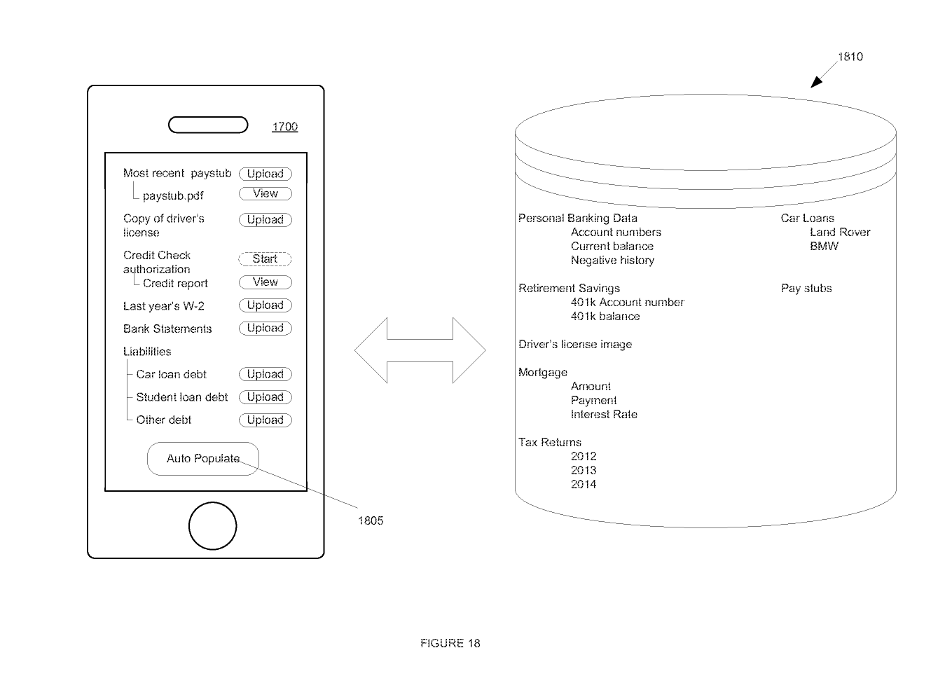

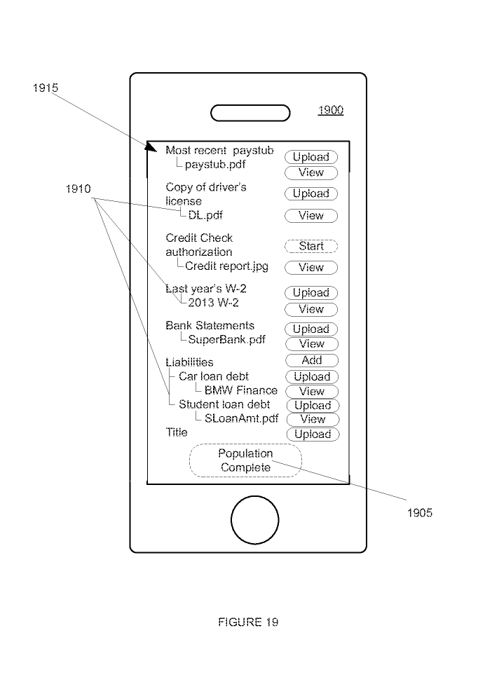

FIG. 18 illustrates an exemplary embodiment of the device 1700 from FIG. 17. However, in this example, the device 1700 has the ability to automatically populate some of template 1720 entries from information collected from the user's PSN. The device 1700 includes a selectable UI object 1805. FIG. 18 also includes a database 1810. In some aspects of the system, the database 1810 may be similar to the database 602 described with respect to FIG. 6.

As shown, the database 1810 may include content that has been saved from previously filled templates or content that the user has chosen to place in the database, such as demographic information or content that may be used for other activities within the system. For instance, in the previous Figures, the user provided a PDF file of a paystub to the templates. The device of each Figure may transmit the uploaded content to the database 1810, which is part of the user's PSN for later use.

In this exemplary figure, the device 1700 may receive an interaction from a user to auto populate the entries of the template 1720. However, as discussed above, in some aspects of the device, the device will automatically populate the template 1720 with as much information as it can without any user interaction. Alternatively or conjunctively, the device 1700 may present a dialog requesting interaction from the user to confirm that addition of each entry to the template. However, even if an undesirable entry is received at the device 1700, it may easily be removed by breaking the dynamic link to the entry.

FIG. 19 illustrates an exemplary embodiment of a device 1900 after a user interaction has been received to auto populate the template (or the template auto populated with out any user interaction). As shown, the device 1900 includes a template 1915, auto populated entries 1910, and disabled selectable UI object 1905. In some aspects of the device, the selectable UI object 1905 may become disabled when no further information is available on the user's PSN to populate the template.

As shown, the entries 1910 include content that was present in the database 1810 of FIG. 18. For instance, the database 1810 included the user's driver's license image, previous years W-2 forms, banking information, and information about the various other loans the user may currently be paying off such as a car loan and student loans. Such information may have been collected from prior templates that the user may have filled out.

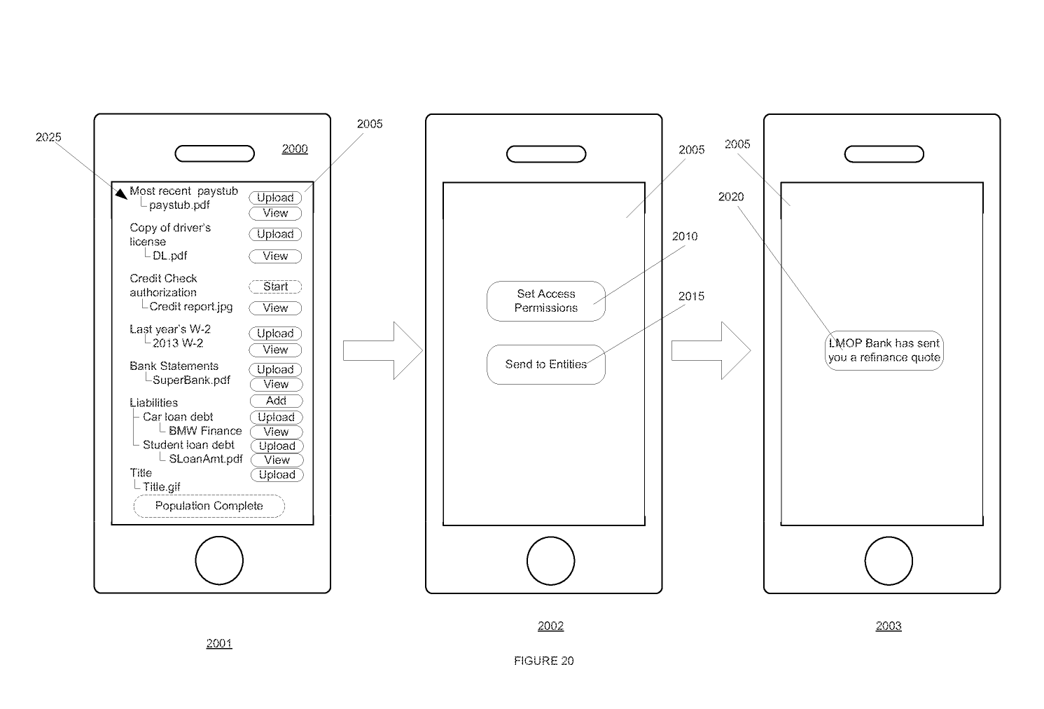

FIG. 20 illustrates the exemplary embodiment of a device 2000 in the process of submitting the template and receiving a response from the submission. The device 2000 includes a display area 2005, template 2025, and selectable UI objects 2010, 2015, and 2020. FIG. 20 illustrates three stages 2001-2003 of a user's interaction with the device 2000.

As shown in the first state 2001, the template 2025, similar to the template 1915 has been completely populated with content. Therefore, the template 2025 is ready to be processed. The device may receive a user interaction with a selectable UI object (not shown) to move onto the next steps in the refinancing process. Alternatively or conjunctively, the device 2000 may receive a gestural interaction such as a swiping motion to display new content in the display area 2005.

In the second stage 2002, the user has performed some sort of interaction with the device 2000 to show new content within the display area 2005. In the second stage 2002, the display area 2005 provides two selectable UI objects for controlling how the content in the template is distributed. Such permissions may be located in the meta data associated with the dynamic link to the content filled template. Thus, in addition to providing dynamic links to individual contents, the inode table 601 may also provide a dynamic link to a content filled template. Therefore, when the template may be removed by breaking the dynamic link.

In this exemplary figure, receiving a selection of the UI object 2010 may grant the user the ability to set permissions at the device such as those described in the previous section. For instance, the device may receive interactions from the user setting temporal, locational, and number of view constraints. For instance, the user may wish to limit the amount of responses received at the device 2000. In doing so, the device 2000 may receive interactions from the user to set a time constraint as well as the number of views the template content may receive. Additionally, the user may wish to limit the scope of views to only those views that are within a specific viewing radius so that, in this example, only local lenders will be able to view the template and respond.

Moreover, the device 2000 may receive a user interaction with the selectable UI object 2015. Upon receiving such an interaction, the device 2000 will transmit the content from the template 2025 by way of one or more dynamic link from the inode table 601, making it available, while still access controllable, to those who may be able to provide lending services to the user. The device 2000 may receive response(s) with information such as rate quotes as well as any other additional costs that may be associated with the refinance process. As discussed above, the content will only be made available to the viewers by dynamic links to the content in the user's PSN database. The device 2000 may receive several responses enabling the user to consider the best option(s) and begin to move forward with the refinance process.

In the third stage 2003, the display area 2005 includes the selectable UI object 2020 indicating that a response has been received from one entity. In this example, a refiance quote has been received from a bank. Upon receiving a selection of the selectable UI object 2020, the device 2000 may display the refinance quote information provided from the bank in the display area 2005. A line of communication with the bank may also be available to the user if he wishes to establish communication. However, it may be at the user's discretion to establish communication with the bank after receiving the offer.

Although the third stage 2003 illustrates only a single response to the submitted content and template, one of ordinary skill in the art will appreciate that several different response may be displayed in different ways in the display area 2005. For instance, the responses may be displayed as selectable items in a grid or list. All of the responses may be maintained until the device 2000 receives user input to discard any of the responses. Alternatively or conjunctively, the responses may pop up on the display 2005 each time one is received. By selecting the pop up, the user may be connected to the system where the offer may be viewed. Each time an offer is closed, a new pop up may appear in the display area 2005.

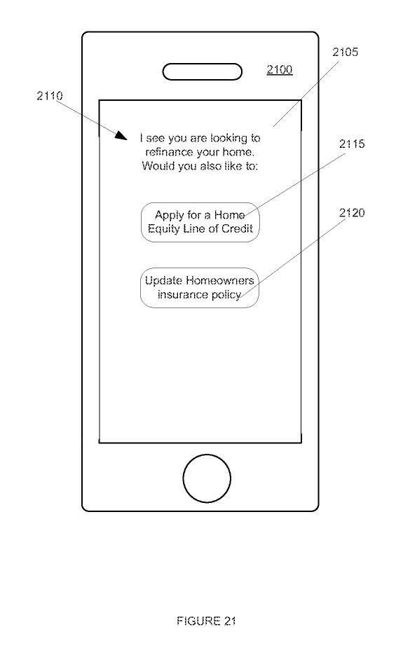

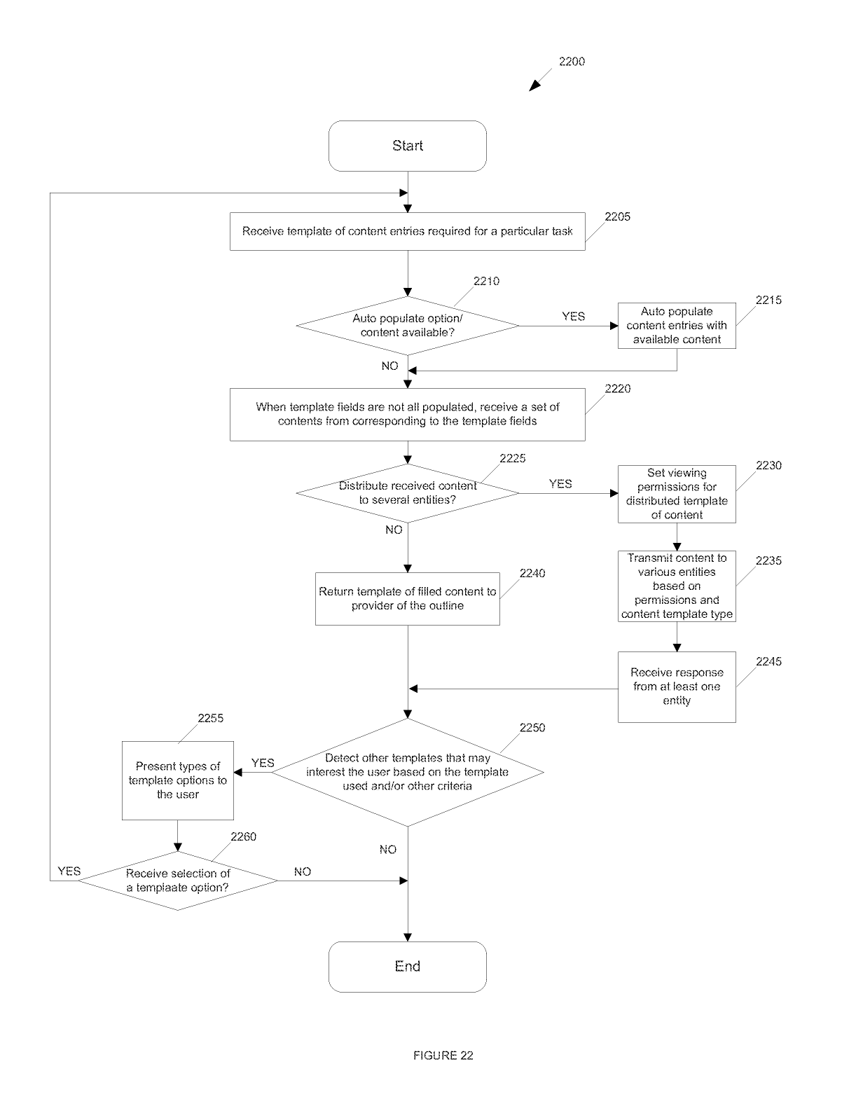

In some aspects of the system, it may be possible to predict other services that a user may benefit from based on certain criteria such as the template that has been filled out, template history, demographic information, search history, viewing history and any combination of the aforementioned criteria, also including analytics. FIG. 21 illustrates an exemplary embodiment of a device 2100 that may present a predicted list of other offers or opportunities to the user.

The device 2100 includes a display area 2105, text 2110, and selectable UI objects 2115 and 2120. As shown, the display 2105 is presenting options that may be desirable to the user based on the fact that a template for refinancing a home was provided by the system for completion by user interaction with a device. As illustrated by the text 2110, the user is invited to complete additional templates that the system predicts may be desirable to the user. For instance, if the user is planning to do some sort of home improvement with savings realized from refinancing, such as install a pool or renovate a room, the user may wish to also apply for a home equity line of credit. Therefore, upon receiving a selection of the selectable UI object 2115, the device 2100 may provide a new template or new options for available crowd sourced templates that may be used for requesting a home equity line of credit. Based on the content received from the previous template, the system may be able to automatically populate many of the template entries at the device 2100 with dynamic links to the content stored in the user's PSN database.

Additionally, the system has predicted the user may wish to take this time to look into new options for a homeowners insurance policy. As such, the display area 2105 includes the selectable UI object 2120, which, upon receiving an interaction from a user will pull up a template or several crowd sourced template options. As with the home equity line of credit template, the homeowners insurance template may also be automatically populated with as much content as was derived from the previously filled template. The content, again, will be viewed by a dynamic link that may be broken at any time of the user's choosing. Therefore, any auto populated content that the user wishes to remove can be easily removed by breaking the link to the dynamic content after receiving a user interaction with the device 2100.

FIG. 22 conceptually illustrates a process 2200 for providing ephemeral, controllable content through a template. The process 2200 may be run on a device such as one of the devices 1600-2100. The process begins after the device has received an interaction from the user to pull up an outline that has either been provided to the device or was found by running a search at the device.

As shown, the process 2200 receives (at 2205) a template of content entries required for a particular task. In some aspects of the process, the template may be a list of entries for which content can be supplied. Alternatively or conjunctively, the template may be an outline of a number of tasks to be performed by the user external from the device. The process 2200 determines (at 2210) whether auto population of the template entries is available. For instance, as discussed in FIG. 18, the device may receive a user interaction to automatically populate any available content from the user's PSN database in the template. However, in some aspects of the process, the process may automatically populate the template without receiving any user interaction when appropriate content is available. In such aspects, the process may then request then indicate to the user which entries could not be populated and request that content be provided for the unpopulated entries. When the process 2200 determines (at 2210) that the auto populate content option is available, the process 2200 auto populates (at 2215) content entries with the available content from the user's PSN database by dynamic link. When the process 2200 determines (at 2210) that the auto populate feature is not available or after the process 2200 finishes auto populating (at 2215) the content entries, the process 2200 receives (at 2220), when not all content fields are populated, a set of contents corresponding to the template. Such entries may be received by user input after auto population when more template entries are still needed. Alternatively, all entries may be received at the device based on user input.

At 2225, the process 2200 determines whether to distribute the content files to several entities. When the process 2200 determines at 2225 not to distribute the received content to several entities, the process 2200 most likely received a template from a template creator such as was described with respect to FIG. 16. In such cases the process 2200 will return (at 2240) the content filled template to the provider of the template. However, when the process 2200 determines (at 2225) to distribute the received content to several entities, the process 2200 sets (at 2230) viewing permissions for the distribution of the template content. The process 2200 then transmits the content to various entities based on the permissions and content template type. The process 2200 receives (at 2245) a response from at least one entity. Although in some aspects of the process it is possible for the process 2200 not to receive any response. The process of distributing content, setting permissions, transmitting the content and receiving a response was described in detail with respect to FIG. 20.

After receiving the response (at 2245) or returning (at 2240) the outline to the outline provider, the process 2200 detects (at 2250) whether other templates may interest the user based on the template used and/or a set of criteria, as was discussed in detail with respect to FIG. 21. When the process 2200 determines (at 2250) that no other templates may interest the user, the process ends. However, when the process 2200 determines (at 2250) that other templates may interest the user, the process 2200 presents (at 2255) types of template options to the user. The process 2200 then determines (at 2260) whether a selection of one of the template options was received. When the process 2200 determines (at 2260) that a selection of one of the template options was not received, the process ends. However, when the process 2200 determines (at 2260) that a selection of one of the template options was received, the process 2200 returns to 2205 to begin the template entry process for the new template.

In some aspects of the system, templates may also be used for life planning, such as estate planning. However, in some aspects of the system, it may be desirable to hold off on estate planning until a later date or it may be desirable to be reminded at some specified duration to revisit the estate documents to confirm that they are up to date and still contain relevant and/or appropriate content.

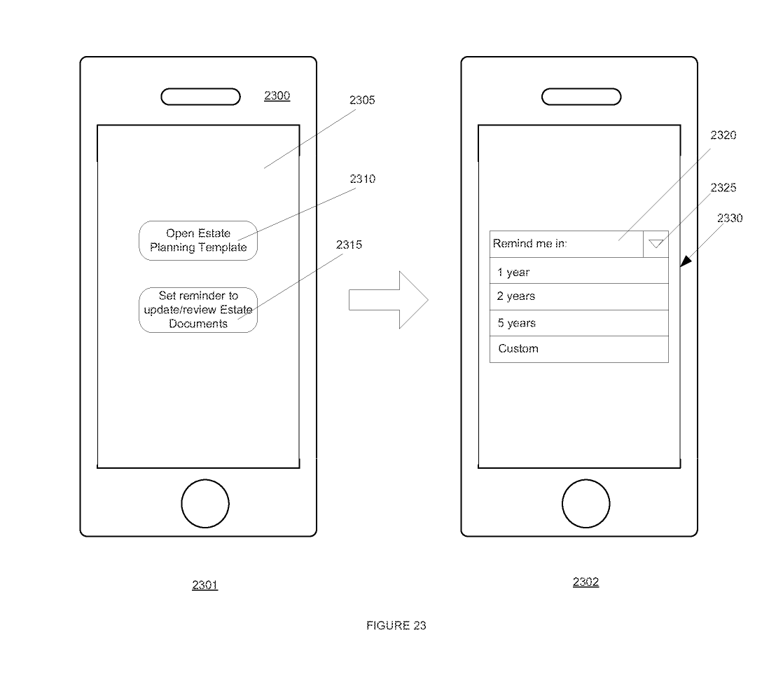

FIG. 23 illustrates an exemplary embodiment of a device 2300 for setting reminders to revisit life planning documents. However, one of ordinary skill in the art will appreciate that the device 2300 is not limited to life planning documents. Any activity that would benefit from periodic temporal reminders may utilize the same features described in the foregoing. However, since documents such as those used for estate planning are typically standard forms, the system makes it simple to receive and update all of the necessary estate planning documents.

The device 2300 includes a display area 2305, selectable UI objects 2310 and 2315, dropdown 2320, selectable dropdown object 2325, and dropdown menu 2330. FIG. 23 illustrates two stages 2301 and 2302 of a user's interaction with the device 2300.

As shown, in the first stage 2301, the user is presented with two exemplary options by way of selectable UI objects 2310 and 2315. Upon receiving a selection of the selectable UI object 2310, the device 2300 may access a new template of forms and required content. Such a template may be associated with the creation of a will or trust. Additionally, the device 2300 may access and display a prior template that the user may have at least started work on. However, upon receiving a selection of the selectable UI object 2315, the device may provide options for selecting a duration of when to receive a reminder from the system to start looking at or update estate planning documents.

In the second stage 2302, the devices 2300 presents the user with the dropdown 2320. Upon selection of the selectable dropdown object 2325, the device presents a dropdown list of durations for setting a reminder to revisit this template or activity. As shown the dropdown menu 2330 has several temporal options to choose from as well as a custom time setting. However, the manner in viewing and selecting the temporal reminders is not confined to the dropdown menu 2330 of the section stage 2302. Any manner of receiving user input such as a text box, radio buttons, or check boxes may be utilized and realize the same outcome.

Upon receiving a selection of one of the dropdown items from the dropdown menu 2330, the system will set up a reminder associated with the user's PSN. Therefore, when the reminder comes due, the system will transmit a message to the user through a device that is accessing the system. For instance, if the device 2300 receives a selection of 2 years, the system will set up a reminder action 2 years from the time of selection to warn the user that it is time to revisit the estate planning template. Of course, the device 2300 may return to the first stage 2301 after receiving a user interaction in response to the reminder and set a new, later reminder.

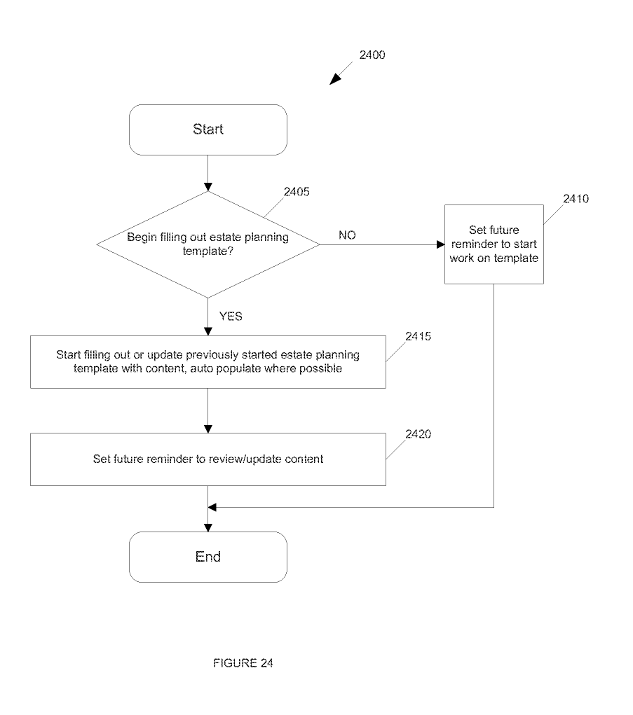

FIG. 24 conceptually illustrates a process 2400 for setting reminders to visit or revisit certain types of templates. Such templates were discussed with respect to FIG. 23. The process 2400 may operation on a client device. The process 2400 may begin after a device is displaying a screen such as the screen in the first stage 2301 of FIG. 23.

As shown, the process 2400 determines (at 2405) whether to begin filling out the estate planning template. Such a determination may be made based on a user interaction received at the device. When the process 2400 determines (at 2405) not to begin filling out the estate planning template, the process 2400 sets (at 2410) a future reminder to start work on the template. The process then ends. Returning to 2405, when the process determines (at 2405) to begin filling out the estate planning template, the process 2400 starts (at 2415) filling out or updating a previously started estate planning template with content. The content may auto populate as discussed above where possible. The process sets (at 2420) a future reminder to review and/or update the content in the template. Then the process ends.

Account Management

In one embodiment of the system, a user creates an account with the system and then can create multiple PSNs as desired. When the user invites members to a PSN, the system determines if the invited user is system member. If so, it can provide access to the PSN. If not, the system offers the opportunity to register in the system to the invited user and, after registering, the invited user becomes a member of the PSN.

An account may be family based, with a primary user and the right for other family members to create sub-accounts, or a specific number of PSNs. The system contemplates tiered pricing structures for various configurations, including number of PSNs, number of users, number of PSN members, and the like.

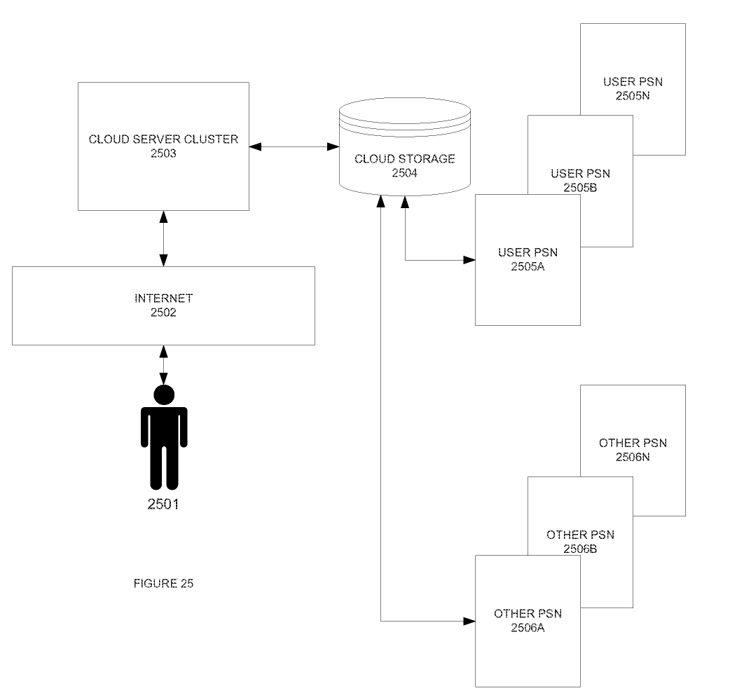

FIG. 25 illustrates an embodiment of the system. A user 2501 accesses the cloud server cluster 2503 via a network such as Internet 2502. The cloud server cluster 2503 interacts with cloud storage 2504 where data for the PSNs created and managed by user 2501 are stored. There may be a plurality of PSNs 2505A, 2505B, through 2505N, depending on how many PSNs the user has created. The user 2501 can also interact with other PSNs of which the user 2501 may be a member, such as PSN 2506A, 2506B, through 2506N.

Example Computer System

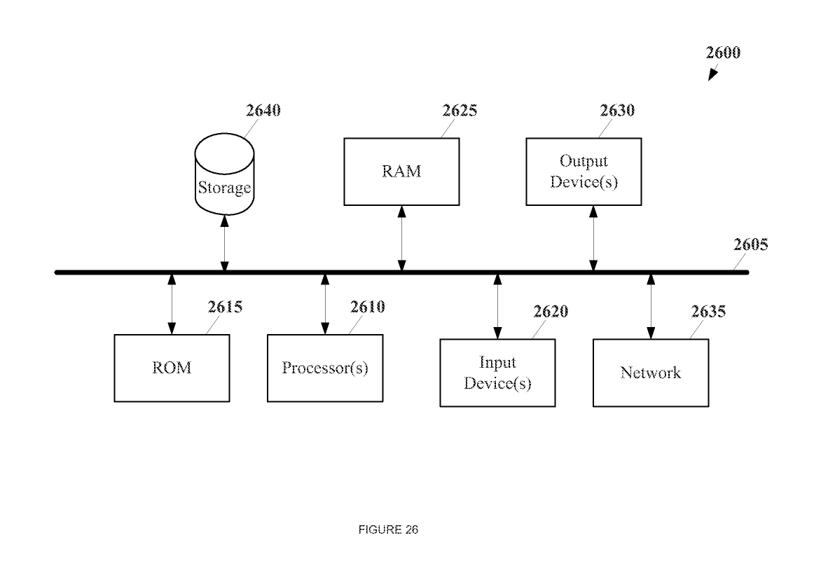

FIG. 26 illustrates an exemplary computer system 2600 that may implement the access controller and/or the access control device. The computer system includes various types of computer readable media and interfaces. The system includes a bus 2605, processors 2610, read only memory (ROM) 2615, input device(s) 2620, random access memory 2625), output device(s) 2630, a network component 2635, and a permanent storage device 2640.

The bus 2605 the communicatively connects the internal devices and/or components of the computer system. For instance, the bus 2605 communicatively connects the processor(s) 2610 with the ROM 2615, the RAM 2625, and the permanent storage 2640. The processor(s) 2610 retrieve instructions from the memory units to execute processes of the invention.

The ROM 2615 stores static instructions needed by the processor(s) 2610 and other components of the computer system. The ROM may store the instructions necessary for the processor to execute the web server, web application, or other web services. The permanent storage 2640 is a non-volatile memory that stores instructions and data when the computer system 2600 is on or off. The permanent storage 2640 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 125 is a volatile read/write memory. The RAM 2625 stores instructions needed by the processor(s) 2610 at runtime. The bus 2605 also connects input and output devices 2620 and 2630. The input devices enable the user to communicate information and select commands to the computer system. The input devices 2620 may be a keyboard or a pointing device such as a mouse. The input devices 2620 may also be a touch screen display capable of receiving touch interactions. The output device(s) 2630 display images generated by the computer system. The output devices may include printers or display devices such as monitors.

The bus 2605 also couples the computer system to a network 2635. The computer system may be part of a local area network (LAN), a wide area network (WAN), the Internet, or an Intranet by using a network interface. The web service may be provided to the user through a web client, which receives information transmitted on the network 2635 by the computer system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

What is claimed is:

1. A method for providing a dynamic link to ephemeral content, the method comprising:
receiving a content from a first device;
receiving a set of permissions associated with the content; and
providing the dynamic link to the content to a second device based on the permissions associated with the content.

2. The method of claim 1, wherein the permissions comprise at least one of time based, location based, user based, and amount of access restrictions.

3. The method of claim 1, wherein the dynamic link is provided when the received set of permissions match a configuration of the second device.

4. The method of claim 1, further comprising denying access to the dynamic link when the configuration of the second device does not match the received set of permissions.

5. The method of claim 1, wherein the permissions are stored in metadata of an inode table, and wherein the links to the content are maintained by the inode table.

6. The method of claim 5, wherein multiple inodes of the inode table link to a same content when multiple devices are granted access to the same content.

7. The method of claim 1, wherein at least one of the set of permissions is time based, and wherein the dynamic link expires after a time period defined by the time based permission passes.

8. The method of claim 1, wherein at least one of the set of set of permissions is location based, and wherein the dynamic link expires when the location moves to a location outside of a location defined by the location based permission.

9. The method of claim 1, wherein the content comprises a secure message from a healthcare provider.

10. The method of claim 9, wherein the secure message from the healthcare provider is shared among a group of healthcare professionals based on the set of permissions.

11. A computer program product comprising a machine-readable medium comprising instructions executable to:
receive a content from a first device;
receive a set of permissions associated with the content; and
provide a dynamic link to the content to a second device based on the permissions associated with the content.

12. The computer program product of claim 10, wherein the permissions comprise at least one of time based, location based, user based, and amount of access restrictions.

13. The computer program product of claim 10, wherein the instructions executable to provide the dynamic link comprise instructions executable to provide the dynamic link when the received set of permissions match a configuration of the second device.

14. The computer program product of claim 10, further comprising instructions executable to deny access to the dynamic link when the configuration of the second device does not match the received set of permissions.

15. The computer program product of claim 10, wherein the machine-readable medium further comprises instructions executable to store the received set of permissions in metadata of an inode table, and maintain links to the content by the inode table.

16. The computer program product of claim 15, wherein multiple inodes of the inode table link to a same content when multiple devices are granted access to the same content.

17. The computer program product of claim 10, wherein at least one of the set of permissions is time based, and wherein the dynamic link expires after a time period defined by the time based permission passes.

18. The computer program product of claim 10, wherein at least one of the set of set of permissions is location based, and wherein the dynamic link expires when the location moves to a location outside of a location defined by the location based permission.

19. The computer program product of claim 10, wherein the content comprises a secure message from a healthcare provider.

20. The computer program product of claim 19, wherein the machine readable medium further comprises instructions excecutable for sharing the secure message from the healthcare provider among a group of healthcare professionals based on the set of permissions.

21. A method comprising:
receiving a template at a device;
populating the template with content, wherein the content is populated by a dynamic link to the content.

22. The method of claim 21, further comprising distributing the outline to at least one other device.

23. The method of claim 22, further comprising restricting said distribution of the content based on a set of permissions.

24. The method of claim 21, wherein the template is a first template, the method further comprising providing a second template to the device based on the first template.

25. The method of claim 21, further comprising setting a reminder to access the template at a future time.

26. A computer program product comprising a machine-readable medium comprising instructions executable to:
receive a template;
populate the template with content, wherein the content is populated by a dynamic link to the content.

27. The computer program product of claim 26, wherein the machine-readable medium further comprises instructions executable to distribute the outline to at least one other device.

28. The computer program product of claim 26, wherein the machine-readable medium further comprises instructions executable to restrict said distribution of the content based on a set of permissions.

29. The computer program product of claim 26, wherein the template is a first template, the machine-readable medium further comprises instructions executable to provide a second template to the device based on the first template.

30. The computer program product of claim 26, wherein the machine-readable medium further comprises instructions executable to set a reminder to access the template at a future time.
